(19) United States
(12) Patent Application Publication
(10) Pub. No.: US 2007/0156343 A1
(43) Pub. Date: Jul. 5, 2007

(54) Stochastic method to determine, in silico, the drug like character of molecules

(76) Inventors: Anwar Rayan, Kfar Kabul (IL); Amiram Goldblum, Jerusalem (IL)

Correspondence Address: Martin D Moynihan;Prtsi Inc, PO Box 16446, Arlington, VA, 22215, US

(21) Appl. No.: 10/569,982

(22) PCT Filed:
(86) PCT No.: PCT/IL04/00765

Related U.S. Application Data
(60) Provisional application No. 60/498,295, filed on Aug. 28, 2003.

(51) Int. Cl. G06F 19/00

(52) U.S. Cl. 702/19

(57) ABSTRACT

A stochastic algorithm has been developed for predicting the drug-likeness of molecules. It is based on optimization of ranges for a set of descriptors. Lipinski's “rule-of-5”, which takes into account molecular weight, logP, and the number of hydrogen bond donor and acceptor groups for determining bioavailability, was previously unable to distinguish between drugs and non-drugs with its original set of ranges. The present invention demonstrates the predictive power of the stochastic approach to differentiate between drugs and non-drugs using only the same four descriptors of Lipinski, but modifying their ranges. However, there are better sets of 4 descriptors to differentiate between drugs and non-drugs, as many other sets of descriptors were obtained by the stochastic algorithm with more predictive power to differentiate between databases (drugs and non-drugs). A set of optimized ranges constitutes a “filter”. In addition to the “best” filter, additional filters (composed of different sets of descriptors) are used that allow a new definition of “drug-like” character by combining them into a “drug like index” or DLI. In addition to producing a DLI (drug-like index), which permits discrimination between populations of drug-like and non-drug-like molecules, the present invention may be extended to be combined with other known drug screening or optimizing methods, including but not limited to, high-throughput screening, combinatorial chemistry, scaffold prioritization and docking.

### FIELD OF THE INVENTION

The present invention relates to a method for new drug detection, drug development and drug design, and in particular, to such a method which is capable of distinguishing between “drug” molecules or substances and “non-drug” molecules or substances.

### BACKGROUND OF THE INVENTION

In the last decade, the issue of predicting the pharmacokinetic fate of molecules has become of utmost importance. This may be mainly due to high costs in drug development, and to the introduction of new techniques such as High Throughput Screening (HTS) techniques and Combinatorial Chemistry, methods that have been widely used by big and smaller pharmaceutical companies in recent years, in order to discover hits and develop leads in their drug discovery programs (Matter, Baringhaus et al. 2001; Ge, Cho et al. 2002).

It is well known that most drug molecules should be preferentially administered by an oral route for greater ease of administration and patient compliance, and therefore issues such as oral availability and bioavailability are of utmost importance. The absorption of a drug through the intestinal tract and its subsequent distribution in the body will determine its ability to be relevant and to have a potential for treating a systemic disease or an organ specific one. In addition, the encounters of that drug with enzymes, in particular with the detoxification enzymes of the liver, are crucial for its duration of activity, because metabolism, conjugation and excretion are prominent reactions of organisms against invaders. Excretion could also become a shortcoming aspect for a drug that is required to remain in the circulation for some time in order to exert its effect. Many compounds pose some risk because of potential harmful activity, and are considered to be “toxic”. Toxicity of compounds is however a matter of concentration, and it can not be easily distinguished from biological activity. In fact, many toxic compounds are so characterized because they possess biological activity that is non-specific, or because they strongly interact with some biomolecules.

Determining the exact balance in each of the components mentioned above is highly complicated. Even if it were possible to predict each and every one of the ADME/Tox (absorption, distribution, metabolism, excretion, toxicity) effects for each molecule, it would still remain complicated to construct a model for a whole body, one that combines the individual effects of each of the ADME/Tox variables into a comprehensive scheme. These effects are not additive, and the overall ADME/Tox profile of a compound cannot be easily determined unless it has extreme values in one or more of these molecular properties (“descriptors”). In searching for proper models to study the separate components of absorption and distribution, problems of water solubility of compounds and assessing their lipophilic character may be solved experimentally or even partially by “in silico” methods of computation. Then, they may be related to ADME/Tox by models (Clark and Grootenhuis 2002). The measured lipophilicity (“logP”) of a molecule has been shown to be related (sometimes by exponential function) to its ability to reach its target in vivo if it has to cross membranes (Wessel, Jurs et al. 1998; Norinder, Osterberg et al. 1999; Egan, Merz et al. 2000). More recently, some in vitro-in vivo directly related models were developed, so that a closer correspondence can be found between them, for example, Caco-2 cell experiments can be good predictors of intestinal absorption (Wessel, Jurs et al. 1998; Egan, Merz et al. 2000). However, such methods are only useful to examine separate factors relating to bioavailability, and particularly oral bioavailability, in isolation; they do not permit direct examination of the interaction between multiple such factors.

In many of the partial tests and examinations of ADME/Tox issues, the goal was mainly to decide whether a compound has the potential to become a drug. The central focus is therefore not on the “solubility” or “lipophilicity” of a molecule, but whether a molecule is “drug like” or not (Ajay, Walters et al. 1998; Clark and Pickett 2000; Frimurer, Bywater et al. 2000; Walters and Murcko 2002): does it have the proper ingredients to be a drug. It is a somewhat different question than one that could be answered by addressing each of the ADME/T issues separately. The need for determining the “drug-likeness” of molecules is especially important in HTS experiments and for Combinatorial Chemistry (Proudfoot 2002; Muegge 2003), in which many compounds are purchased or synthesized, with the aim to introduce them into some accelerated test that seeks hits for some biological target that is related to a disease.

Saving on the number of compounds could become detrimental for preparing such a HTS experiment, and the issue of “drug-likeness”, the ability to determine a molecule's potential to become a drug, was proposed in order to reduce the expenses for testing too many and frequently unnecessary numbers of compounds. Thus, the interest and need to screen molecular properties directly from their one or two dimensional formulae, in silico rather than in the test tube, has been raised and expanded. In most cases, marketed drugs differ largely from the starting hits and from lead compounds in their “drug likeness”. If the hits are already “drug like” or if “drug like” leads could be developed from the hits of HTS, then, much time and money could be saved. Hits are molecules that display activity in the HTS experiments. Leads are molecules which are developed to become drug candidates. Leads are at a more advanced development stage compared to hits. It has become important not only to predict which molecules have a low chance of becoming drugs and should thus be abandoned but also, which hits have a greater chance to become leads, and which leads should be preferentially developed.

A landmark in such predictive ability has been set by Lipinski (Lipinski, Lombardo et al. 1997; Lipinski 2000), who proposed a few “rules of thumb” for acquiring molecules to biological HTS tests or for combinatorial synthesis. According to Lipinski, if a molecule violates more than one condition out of the following, it is expected to have a low oral availability and therefore will most likely not be useful for testing as a potential drug and should be excluded from the test:
Molecular weight ≦500
Number of hydrogen bond donors ≦5
Number of hydrogen bond acceptors (including those in donor groups) ≦10
ClogP ≦5.0 (or MlogP ≦4.15) (calculated rather than measured lipophilicty)

This “rule of 5” of Lipinski (all numbers are multipliers of the number 5) is thus a “filter” according to which each molecule should be tested, in order to decide whether it should be further developed.

Lipinski's rule of 5 revolutionized the field because it showed that simple molecular descriptors could be employed to predict, even though on a general and statistical basis, the outcome of biological experiments. In fact, this was already known from the work on Quantitative Structure Activity Relations of Hansch et al. in the 60's. The difference between the two methods is that the Hansch approach, based on physical chemical mechanistic thinking, can rationalize the activities of congeneric series even to the extent of quantitative predictions, but on condition that they share similar mechanisms of action. Lipinski's rule is of qualitative nature, but transcends the structural limits of a series and does not require mechanistic similarity. Although Lipinski's rule only addresses the issue of oral availability, it is not surprising to find that researchers questioned whether the scope of the “rule of five” could be extended for distinguishing between drugs and non-drugs. For many drugs, oral availability and drug-likeness are not expected to be very different properties, since oral availability is such a crucial factor for most drugs. In fact, most molecules are not expected to be useful drugs if they are not well absorbed orally and later, in the intestinal tract, and hence become “bioavailable”. More recently, a few other rules such as the molecular accessible surface and number of rotatable single bonds were proposed for distinguishing bioavailability (Veber, Johnson et al. 2002).

Despite this obvious relation between drug likeness and oral availability, attempts to apply Lipinski's rule to the determination of “drug likeness” have not been successful. Such determination is examined by using the rule of five as a “filter” for molecules that are found in a database of compounds. Application to single molecules can not be successful because Lipinski's rule itself is based on statistics of many orally available molecules. There are therefore quite a few drugs that are “non-Lipinski”, i.e., they “violate” the rule.

Suitable databases are supplied by a few companies, and may also be constructed from the literature or from other resources. Most of the examinations of the drug likeness in the literature have been mentioning some databases that are widely known today, such as CMC (Comprehensive Medicinal Chemistry, by MDL Inc., which contains a few thousand drug molecules) (http://www.mdl.com/products/knowledge/medicinal_chem/index.jsp), MDDR (Medicinal Drug Data Report, by MDL Inc., which contains many thousands of molecules that are in biological testing, some in preclinical and others in clinical such as phase I, etc.) (http://www.mdl.com/products/knowledge/drug_data_report/index.jsp), ACD (Available Chemicals Directory, by MDL Inc., containing ˜250,000 molecules that may be purchased from chemical companies) (http://www.mdl.com/products/experiment/available_chem_dir/index.jsp) and other databases.

Some reports discussed the potential of Lipinski's rule of five to discriminate between drugs and non-drugs (Walters, Murcko et al. 1999; Oprea 2000). Frimurer et al. reported results that demonstrate that the quality of the discrimination between drugs (MDDR database) and non-drugs (ACD database), by employing the “rule-of-five”, is not better than a random guess. The direct implication of such a statement is that distinguishing between drugs and non-drugs should require approaches that are more complex. Indeed, that same group (Frimurer, Bywater et al. 2000) as well as a few others who investigated this issue earlier (Ajay, Walters et al. 1998; Walters, Murcko et al. 1999; Sadowski 2000) used “Neural Networks” approaches to distinguish between drugs and non-drugs. Although much improved compared to the use of Lipinski's rule, results of neural networks are not easily interpreted in terms of the structural components and they do not provide information that could be exploited for synthesizing new molecules. An attempt to determine drug likeness in a more quantitative manner was proposed by Xu and Johnson, who proposed a “Drug Like Index” that is based on molecular fragments of structures (Xu and Stevenson 2000).

Distinction between drugs and non drugs may be determined by using databases and statistical methods, which rely upon large collections of data for efficiency and accuracy. These methods assume that drugs have common features that are not easily recognized if only a small number of drug molecules are examined. Therefore, if a larger number of drug molecules in a database or a sample is provided, more significant conclusions can be drawn concerning these molecules. It is also important to examine databases of non-drugs, in order to compare and to look for differences. Databases of drug molecules contain information about the molecular formula and connectivity (ie chemical bonds between atoms and groups or moieties), and about the type of drug activity. Analysis of a database of drug molecules may thus reveal details about the characteristics of such molecules and facilitate the production of other drug molecules. Further, structural components that are common to a certain drug activity may be discovered and used in analysis and predictions.

The main databases of drugs have been organized according to Food and Drug Administration (FDA) decisions, or based on announcements of advanced biological tests such as the various clinical phases (Oprea 2000; Brustle, Beck et al. 2002). A database of non drugs is a less specific resource (Sadowski 2000), because it is in most cases a database of molecules that have not been tested yet for biological activity, and are in many cases molecules that are marketed, and not intended for biological test purposes. It has been suggested that, in the non-drug databases, some 70-80% of the molecules do not have the potential to become drugs, or are “true” non-drugs while the rest (or about 20-30%) could be drugs at some concentration. While taking these limitations into account, such databases have still been widely used by researchers for distinguishing drugs from non-drugs, by diverse methods of prediction and optimization. For example, such databases may be used to “tune” methods, as well as to test whether such methods function correctly (i.e. are actually able to distinguish drugs from non-drug molecules). However, to date, even using such databases has not enabled users to solve the problem of distinguishing drugs from non-drug molecules in a meaningful fashion, that enables the construction of new molecules.

It thus seems that the intricacy of biological activity and the large number of potential physical descriptors of molecular structure require special technologies that can deal with such complex problems, if these problems can be solved at all.

Clearly therefore, an improved method is required which would overcome the limitations of the combinatorial nature of the problem of drug likeness in order to provide more accurate in silico testing of potential drug molecules or substances.

### SUMMARY OF THE INVENTION

The background art does not teach or suggest a method which provides accurate in silico testing of a molecule's potential to be a drug or to have particular properties as a drug. Therefore, there is no reasonable prioritization of molecules that determines which molecules would be more likely to become drugs.

The present invention overcomes these drawbacks of the background art by providing a stochastic algorithm for predicting the drug-likeness of molecules (e.g. suitability of a molecule to potentially be used as a drug). It is based on optimization of ranges for a set of descriptors and on an optimal choice of sets of descriptors. The present invention is capable of distinguishing between populations of drug-like and non drug-like molecules, according to at least one but preferably a plurality of characteristics of each type of molecule. Some exemplary characteristics are described below, but optionally different or additional characteristics may be used. The ability of a particular molecule to fall within the area defined by the characteristic(s) is therefore related to whether that molecule is more drug-like or more non-drug-like. Thus, such characteristics are preferably assembled into filters, such that molecules that do not fall within the area defined by the characteristics are excluded from the population of drug-like or non-drug like molecules.

According to preferred embodiments of the present invention, there is also provided a method for determining the best set of molecular properties (“descriptors”) that fit best to the “drug like character” of molecules. This method assists with the above optimization process.

According to still other preferred embodiments of the present invention, there is also provided a method for prioritizing molecules from huge databases, optionally on the sole but preferably on the primary basis of their “drug like index”, and/or (alternatively or additionally) on the combined basis of their affinity to a target and their “drug like index”.

According to yet other preferred embodiments of the present invention, there is also provided a method for constructing candidate lead compounds by addition of substituents or of “side chains” in order to improve drug-likeness. Substituents are molecular fragments that may be added to a given molecular scaffold on the basis of chemical knowledge or intuition, and may subsequently be examined by a proper computer program of chemical synthesis or by synthesis experts. The addition of substituents is done in silico by replacing hydrogen atoms of a scaffold by substituents out of a large substituent list (Ertl 2003). Each position could in principle carry any of the substituents of the list (“database”), and therefore, if such a list contains hundreds or thousands of substituents, the number of combinations that would result in the creation of new molecules is enormous. For n scaffold positions and m substituents, the size of the full set of combinations is mⁿ. The method of the present invention involves a search for substituents that could improve the drug likeness of the molecule while increasing or at least not affecting its biological activity.

According to still other preferred embodiments of the present invention, there is also provided a method for combining docking of a ligand to a protein or other structural target, with the method of the present invention for selecting one or more candidate lead compounds on the basis of their “drug-like” characteristics. Docking methods are well known in the art (Goodsell and Olson 1990; Rarey, Kramer et al. 1996; Jones, Willett et al. 1997; Knegtel, Kuntz et al. 1997; Sun, Ewing et al. 1998; Bohm, Banner et al. 1999; Charifson, Corkery et al. 1999; Knegtel and Wagener 1999; Claussen, Buning et al. 2001; Diller and Merz 2001; Doman, McGovern et al. 2002; Glick, Grant et al. 2002; Paul and Rognan 2002; Shoichet, McGovern et al. 2002; Wang, Lu et al. 2003), and involve computational modeling of the potential three-dimensional interactions of a ligand to a protein or other biological target, presented as computational three-dimensional structure models or structural representations. The ligand may itself be a protein or peptide, but is preferably, in most cases, a “small molecule” of molecular weight <1000. Optionally, the target may not be a protein, and/or may comprise a plurality of proteins, or a protein/non-protein combination, such as (for example) a protein embedded in a membrane and water environment, in the case of G-protein coupled receptor targets, as a non-limiting, illustrative example. Using the method of the present invention in combination with such a docking method provides a synergistic effect, since docking methods examine the “affinity” between a ligand and a target, and may therefore provide part of the “pharmacodynamic” profile of a drug molecule. The method of the present invention is able to bring information about the characteristics of a molecule that may be helpful when administering a medication to a subject, since such administration involves also the interaction of the ligand with at least a part of the body of the subject. This interaction, considered to be the “pharmacokinetic” profile of a drug, includes all the movements of the drug along its path to the target to which it has affinity. Thus, the combination enables consideration of the main factors of drug activity in combination and simultaneously.

Docking itself is a term for a general process that predicts how small molecules meet with biological targets such as proteins (SU, Lorber et al. 2001; Doman, McGovern et al. 2002; Lorber, Udo et al. 2002; Shoichet, McGovern et al. 2002). Most of the current approaches to docking attempt to predict the statistical likelihood of the outcome of the meetings between huge numbers of small molecules, preferentially organized in “virtual libraries” (in which the number of molecules may be in the millions) with the same target. Correct searching of the small molecules' positions at the biological target, and correct “scoring”, i.e., evaluation of the energy for each such position, form the necessary basis for being able to prefer one molecule over another through use of the docking method. The molecules to be docked may be known or yet unknown molecules. The process of docking many molecules is also known as “virtual screening”: it mimics the process of biological/chemical screening with “robots”, but is different in that the process is performed computationally in order to save time and money.

More generally, the present invention has (among many advantages) the clear advantage of being able to provide a single number for any molecule which encompasses many different factors and the relationship between these factors. Optionally, the present invention may be used to provide a plurality of parameters, but again such parameters represent both the interaction of a plurality of factors, since the present invention is able to capture the interactions between characteristics of drugs without requiring all or even any of these characteristics to be absolutely identified. Furthermore, the relationships between some or even any of these characteristics do not need to be absolutely identified. Thus, the present invention is operative even in the situation in which the characteristic(s) which cause a molecule to be “drug-like” are not identified, eg represent a “black box”.

The present invention provides a greater predictive power than that of Lipinski or equivalent predictions by other methods that identify molecular properties or components, while it preserves the ability to propose values of descriptors for determining the property of “drug likeness”, thus permitting construction of molecules with properties that improve their chances to become drugs. Moreover, as an example of its strength, the method is able to differentiate more accurately between drugs and non-drugs than Lipinski's rule by using the very same four descriptors of Lipinski, but by optimizing their ranges. A set of optimized ranges constitutes a “filter”. In addition to the “best” filter, the method of the present invention also preferably involves obtaining additional filters that allow a new definition of “drug-like” character by combining them subsequently into a “drug like index”. The resulting Matthews correlation coefficient (MCC) for differentiating between two databases, of drugs and of non-drugs, has values of 0.35 (for the training set as well as test set of CMC/ACD) and 0.48 (for the training set of MDDR/ACD) and 0.474 (for the test set of MDDR/ACD) for using the Lipinski variables with values that were modified by our method, and are different than the original ones of Lipinski's rule. This particular “filter” (with MCC=0.48 for MDDR/ACD) is equivalent to about 74% success in the prediction of the two databases, as well, MCC=0.35 for CMC/ACD is equivalent to about 67.5% success in the prediction of the two databases. This value should be compared to an MCC value of −0.03 for CMC/ACD, close to the random 50% success for predicting if a molecule is in the drug database or in the non-drug one and even more worse for MDDR/ACD (MCC=−0.17). That low predictive value is reached if MCC is determined by employing the original ranges of Lipinski's “rule of five”.

Lipinski's “rule-of-five”, which determines the oral availability of drugs by taking into account molecular weight, logP, and the number of hydrogen bond donor and acceptor groups is thus unable to distinguish between drugs and non-drugs with the original set of ranges proposed by Lipinski. The much more accurate results with the method of the present invention were obtained by using new ranges of Lipinski's descriptors to discriminate between the databases, by modifying and optimizing them as a combinatorial set for actual use for predicting the drug-likeness of a molecule, preferably in the form of a drug-like index.

The “drug like index” (DLI) is optionally and preferably constructed according to a formula that uses the true and false positives, as well true and false negatives in any set of best results that were obtained by this stochastic optimization of descriptors and of descriptor ranges. This DLI may optionally be used for prioritizing molecules in any set of given structures, preferably within large data sets of molecules in High Throughput Screening for molecular hits, in preparing lists of Combinatorial Chemistry for synthesis, or in assigning structures for High Throughput in Silico Docking of molecules, among many potential applications of the DLI. Also it is optionally useful for optimization of hit compounds toward leads and of leads toward drugs by combinatorial addition of substituents that optimize their drug likeness. In the docking experiments, DLI may be combined with scores for the affinity. DLI may be used to decide how to reduce compound sets so that smaller sets could be examined (by HTS) or synthesized (by Combinatorial Chemistry), in each of the above or in any other equivalent situations, thus saving time and money.

It should be noted that the present invention differs from the background art in many ways. For example, as noted above, the present invention is able to provide a number that describes many different aspects of the “drug-like” qualities of the molecule. The present invention also is able to combine and refine previously known methods, such as docking, with the new methods to evaluate drug-likeness, and to obtain synergies from these combinations.

Previously, the current inventors published a stochastic algorithm (Glick and Goldblum 2000; Glick, Rayan et al. 2002), which differs from the present invention in many aspects. For example, the method for evicting variable values has been transformed in the method of the present invention Second, in the new version, the size of each sample is many times larger than in the previous version. These large samples allow the “lowest values” and “highest values” regions (L and H regions, respectively) to be used with much more confidence compared to the older version. In fact, the sizes of the L and H regions described in greater detail below (“Elimination of values” section below) are as large, each, as the former full sample. The time for gathering such a sample is naturally much longer. However, with such large L and H regions of the sample, many more values can be evicted in each iteration than the single variable value which was the maximal size for eviction in the older version. Therefore, with the large samples of the current version, all values of each variable may be tested for their real versus statistical (non biased) distribution in each iteration. The overall number of iterations is reduced considerably with respect to the previous version, in which the number of iterations was on the order of the number of the values, for the variable which had the maximum such values. Thus, in the previous version, if a variable would have 200 values, some 200 iterations would be required to reach the exhaustive stage (below). In the current version, this number is many times smaller and is in the range of single iterations.

In the present version, a decision to evict a value is made on the basis of comparing the real and statistical distributions. In the previous version, no such comparison was attempted, but eviction was based on consistency in appearance in the “bad values” region with no contribution to the “good values” region, both regions being much smaller in size (2-10 compared to hundreds or more) than in the present version. Also, the tests for eviction in the present version are different: decisions are done by analyzing the L and/or H regions together or separately. In the previous version the H region as well as the L region were probed together before making a decision to evict any value. Finally, in the present version one may evict many values of a single variable in a single iteration. In the former version, only a single value could be evicted in each iteration (an iteration constitutes the set of tests for evictions, on each sample). These iterations lead from a large set of potential filters at the beginning, to a much smaller set of solutions that are studied exhaustively and finally form the set of best filters for discriminating between the two databases, of drugs and of non-drugs, or any other pairs of databases that can be distinguished on the basis of some property and may be described by “descriptors”.

According to the present invention, there is provided a method for discriminating between a potential drug molecule and a potential non-drug molecule, comprising: providing a database of a plurality of drug molecules and a database of a plurality of non-drug molecules; partitioning the databases of drug molecules and non-drug molecules, into a training set and a test set for each database; calculating values for at least one physicochemical descriptor for all the molecules in the two sets; determining upper and lower limits of values for the at least one physicochemical descriptor; applying a stochastic search for optimizing the values of the upper and lower limits of descriptors for the molecules; scoring ability to discriminate between drug and non-drug molecules; and discarding values that do not contribute to optimization of the ability to discriminate, thus optimizing the ranges between the upper and lower limits for each descriptor.

The method may optionally and preferably further feature constructing histograms of the descriptors for determining the upper and lower limits and for determining the discrete values of each descriptor, and more preferably may further feature assigning, to each physicochemical variable, at least one descriptor, or two, in which one for the lower limit of its range of values, and the other for the upper limit. Optionally, the ranges overlap.

The method may optionally further comprise: continuing iterating and reducing the number of variable values until a predefined endpoint is achieved; switching from stochastic to an exhaustive calculation of all remaining options.

The method may optionally further comprise: sorting the results from the optimum “best filters” up to lesser results. The method may optionally further comprise: selecting a plurality of filters according to optimization of the filters; and applying the plurality of filters by combining them to obtain a drug like index for scoring any number of desired molecules, and examining the scoring of the drug like index by applying it to the training set and to the test set for determining performance of the filters.

The method may optionally further comprise: combining a number of the plurality of filters to obtain a drug like DLI (drug like index) for distinguishing between drug and non-drug molecules.

Optionally and preferably, the filters comprise at least one descriptor from the plurality of available descriptors. More preferably, an equation for determining whether a molecule is drug-like comprises an efficiency factor as part of the computation of the drug like index.

Optionally and preferably equation for determining whether a molecule is drug-like comprises:

$$DLI = \frac{{\sum }_{i = 1}^{n} {δ}_{Di} \frac{{P}_{Di}}{{P}_{NDi}} - {δ}_{NDi} \frac{{N}_{Di}}{{N}_{NDi}}}{n}$$

Wherein n is the number of filters, and n can optionally and preferably be a number ranging from a few to thousands, value of delta functions δ_{Di} and δ_{NDi} are set according to whether the molecule is a non-drug or a drug according to the currently calculated filter i, P_{Di} is the percentage of drugs that are predicted to be “drugs” according to filter i, while P_{NDi} is the percentage of false positives, N_{Di} is the percentage of drugs identified to be non drugs according to the current filter, and N_{NDi} is the percent of non-drugs identified by the current filter.

The method is optionally implemented such that a value of delta function δ_{Di} is 0 (Zero) if said molecule is a non-drug according to the currently calculated filter i, and 1 if it is a drug according to that filter, and wherein a value of the delta function δ_{NDi} is 1 if it is a non-drug according to the currently calculated filter, and 0 if it is a drug according to that filter.

Optionally and preferably a quotient P_{Di}/P_{NDi}, is said efficiency factor of filter i for identifying drugs, and a quotient N_{Di}/N_{NDi} is said inefficiency factor for misidentifying non-drugs.

According to preferred embodiments of the present invention, there is provided a method for discriminating between a first type of item having a first characteristic and a second type of item having a second characteristic, comprising: providing a database of a plurality of items of the first type and a database of a plurality of items of the second type; partitioning the databases of items of the first and second types, into a training set and a test set for each database; calculating values for at least one descriptor for all the items in the two sets; optionally and preferably, determining upper and lower limits of values for the at least one descriptor; applying a stochastic search for optimizing the values of the upper and lower limits of descriptors for the items; scoring ability to discriminate between items of the first and second types; and discarding values that do not contribute to optimization of the ability to discriminate.

According to preferred embodiments of the present invention, there is provided a method for partitioning a set of molecules into a first set of at least one drug-like molecule and a second set of at least one non drug-like molecule, comprising: determining a statistical distribution of values for at least one characteristic over the set of molecules; and partitioning the set of molecules into the first and second sets according to the statistical distribution.

Preferably, the determining the statistical distribution of values is performed by: providing a first database of a plurality of drug-like molecules and a second database of a plurality of non drug-like molecules; selecting the at least one characteristic according to an ability of the at least one characteristic to distinguish between molecules in the first and the second databases.

Optionally and preferably, the ability of the at least one characteristic is determined by: calculating the values of the physicochemical descriptors of interest for all the molecules in the two sets; and determining a number of drug-like and non drug-like molecules partitioned according to the calculated values.

Preferably, the calculated values are calculated according to histograms of the descriptors.

Also preferably, the determining the number of partitioned molecules further comprises: performing a stochastic search for optimal value or values of the descriptors; and partitioning the molecules according to the optimal value or values.

The method preferably further features: performing an exhaustive search when a number of possible value or values of the descriptors is reduced to a threshold level.

The method preferably further features: selecting at least one optimal physicochemical descriptor.

Preferably, the selecting the at least one optimal descriptor comprises: selecting a plurality of sets of descriptors, with a predefined range for each descriptor; and optimizing ranges of the sets of descriptors.

More preferably, the optimizing the ranges further comprises: for a predetermined number of descriptors, n>1, applying a stochastic search for selecting the best sets of n descriptors; discarding non-contributory descriptors; and sorting results to obtain at least one optimal descriptor.

Most preferably, the stochastic search is applied according to a cost function comprising the Matthews correlation coefficient as the scoring function to measure the ability to differentiate between drugs and non-drugs in the training set.

Also most preferably, the searching, discarding and sorting are repeated at least once. Preferably, the searching, discarding and sorting are repeated until a threshold is reached.

Optionally and preferably, the selecting the at least one optimal descriptor comprises: assigning three variables to each descriptor, a first variable for the lower limit of its range of values, a second variable for the upper limit, and a third binary variable or a “probability variable” with discrete values between zero and one; performing a stochastic search for selecting the best sets of descriptors; discarding non-contributory descriptors; and sorting results to obtain at least one optimal descriptor.

Preferably, the ability is determined according to a predetermined threshold for discriminating between drug-like and non drug-like molecules.

More preferably, the predetermined threshold is determined according to a cost function.

Most preferably, the function comprises the Matthews correlation coefficient.

Optionally and preferably, the determining the statistical distribution of values is performed by: providing a first database of a plurality of drug-like molecules and a second database of a plurality of non drug-like molecules; and selecting at least one filter for determining a cut-off between drug-like and non drug-like molecules according to an ability to discriminate between molecules in the first and second databases.

More preferably, the selecting the at least one filter comprises selecting a plurality of optimum filters in combination.

According to preferred embodiments of the present invention, there is provided a method for distinguishing between a population of drug-like molecules and a population of non-drug like molecules, comprising: determining a plurality of characteristics of the population of drug-like molecules and the population of non-drug like molecules; providing a third population of molecules; filtering the third population according to the plurality of characteristics; and partitioning the third population according to the filtering, wherein the partitioning is performed according to a cut-off threshold, the cut-off threshold determining a degree of similarity of molecules in the third population to the plurality of characteristics of the population of drug-like molecules and a degree of non-similarity of molecules in the third population to the plurality of characteristics of the population of non-drug like molecules.

The method preferably further features: determining a DLI (drug-like index) value for each molecule, the DLI forming a cut-off threshold for partitioning the molecules.

The method preferably further features: selecting a target for being bound by a drug-like molecule; performing docking to model an interaction of each molecule with the target; and combining a result of the docking with the DLI to select at least one molecule.

The method preferably further features: providing a library of molecules; partitioning the library of molecules according to the DLI; and selecting drug-like molecules after the partitioning for high throughput screening.

The method preferably further features: virtually examining a plurality of scaffolds, each scaffold having a plurality of substituents at a plurality of positions; partitioning the scaffolds according to the DLI.

The method preferably further features: selecting drug-like scaffolds according to the partitioning; and selecting a plurality of substituents for the drug-like scaffolds according to the partitioning.

Preferably the selecting comprises prioritizing the drug-like scaffolds and substituents for performing a screening assay. Such a screening assay optionally and preferably comprises a biological assay such as an in vitro assay for example; such an assay could easily be selected by one of ordinary skill in the art.

Optionally and preferably, the process of selecting comprises prioritizing the drug-like scaffolds and substituents for a screening assay.

Also optionally and preferably, the process of selecting comprises prioritizing the drug-like scaffolds for selecting at least one lead for a new potential drug.

### BRIEF DESCRIPTION OF THE DRAWINGS

The invention is herein described, by way of example only, with reference to the accompanying drawings:

FIG. 1 shows a flowchart of the procedure for predicting drug-likeness according to the present invention; and

FIGS. 2A-D show histograms for the 4 Lipinski descriptors used in this study. Each histogram includes the values for both the cleaned CMC database (“drugs”) and for the cleaned ACD database (“non drugs”) (for this example, randomly selecting around 4% of the molecules in the entire ACD). All histograms are normalized. FIG. 2a presents the distribution of molecular weights in the drug and non-drug databases. FIG. 2B presents the calculated logP (calculated lipophilic constant, for equilibration of a molecule between n-octanol and water). FIGS. 2C and 2D present, respectively, hydrogen bond donors (all OH and NH groups) and hydrogen bond acceptors (all O and N atoms).

FIGS. 3A, 3B and 3C show different illustrative methods according to the present invention for selecting descriptors.

FIGS. 4A-B show the DLI for drugs and non drugs as follows. FIG. 4A shows DLI results for 300 molecules of each of the databases ACD, MDDR and CMC (scatter plot of the DLI values of 300 molecules from each of the three databases: CMC, MDDR and ACD. Y axis values are DLI values. X axis values are numbers of molecules). FIG. 4B shows the spread of DLI values for the three databases, from DLI values based on 215 filters.

FIG. 5 shows the MCC, True Positives (TP) and True Negatives (TN) values as they change along the DLI cutoff value. At each DLI cutoff value presented on the x axis, the TP value presents the fraction of true drugs having DLI values above this threshold and the value of TN presents the fraction of true non drugs having DLI values less than this threshold. The MCC of equation 1 is calculated according to the following definition of the molecules' category: true positives are drug molecules from the drug database having DLI equal or above a defined DLI cutoff, while other drug molecules from the same database (drug database) having a DLI less than the defined DLI cutoff are considered false negatives. True negatives are non-drug molecules from the non-drug database that have DLI less than a defined DLI cutoff while the rest of non-drug molecules from the non-drug database which have DLI equal or above the defined DLI cutoff are to be considered false positives.

FIG. 6 shows an illustrative schematic method according to the present invention for the combination of DLI with HTS.

FIG. 7 shows an illustrative schematic method according to the present invention for the combination of DLI with creating lead molecules by adding substituents to core molecules.

FIGS. 8A-B show an illustrative schematic method according to the present invention for the combination of DLI with docking, with FIG. 8A showing a first exemplary embodiment, and FIG. 8B showing a second exemplary embodiment.

### DETAILED DESCRIPTION OF PREFERRED EMBODIMENTS OF THE INVENTION

The present invention is of a method for predicting the drug-likeness of molecules (e.g. suitability of a molecule to potentially be used as a drug). It is based on assigning the best descriptors out of a large number of descriptors of molecular properties, and of optimizing the ranges for this set of descriptors. A set of optimized ranges constitutes a “filter”. In addition to the “best” filter, the method of the present invention also preferably involves obtaining additional filters that allow a new definition of “drug-like” character by combining them into a “drug like index”. The method of the present invention uses aspects of a previously developed algorithm by certain of the same inventors, which can search highly complex combinatorial problems and reduce their complexity, in iterations. The initial stages require stochastic construction of samples that are scored by a cost function and subsequently examined for the contribution of variable values to the best and worst solutions in a large, statistically meaningful sample. This serves as a basis for discarding values in iterations, thus reducing the size of the combinatorial space of the initial set of variable values to a manageable number, from which a full exhaustive search can ensue. A different version of this algorithm was applied previously to protein structure problems such as rotamer positions on a given backbone (Glick, Rayan et al. 2002) and polar proton positions in crystal structures (Glick and Goldblum 2000). In these problems, the number of iterations was determined in principle by the maximal number of values that any variable had, initially. If, for example, a side chain had 80 potential rotamers, only one rotamer could be discarded in each iteration, and therefore a few dozens of iterations would be required to eliminate most of them.

The present invention requires a substantial modification to this algorithm, in order to reduce the number of iterations and to separate between the number of variable values and the number of iterations. Sample sizes have been substantially expanded, and therefore it is possible to examine the advantage of each variable value at the end of a single sampling process, which optionally and preferably constitutes one iteration.

With regard to the present invention, the modified algorithm was applied to solve other problems in chemo-informatics such as selecting a certain set of descriptors out of a large set and for optimizing the ranges of the descriptors to obtain the best solution for differentiating between databases. For each descriptor, it is possible to optimize the range which best predicts, among all ranges of that descriptor, the drug-likeness of molecules. Extensions of such predictions involve simultaneous optimization of the ranges of a few descriptors. Among those was the set of the four descriptors of Lipinski's “rule of five” which were optimized in order to demonstrate the possibility to distinguish between drugs and non-drugs even with “Lipinski variables”. It is also possible to optimize, at once, both the number of descriptors out of a large list of descriptors as well as their ranges. Results are sets of descriptors and their optimal ranges that predict drug likeness better.

The results of the optimization of descriptors and ranges may be employed for prioritizing molecules in large databases: either existing ones that form the basis for HTS compound lists, or combinatorial chemistry ones that are prepared for synthesis. In addition, lists of molecules for “virtual screening” by docking in Silico may also be prioritized on the basis of the Drug Like Index of molecules, as described in greater detail above. Also, it is possible to use the DLI to construct candidate lead compounds by additions of substituents to given scaffolds, as described in greater detail above.

### Example 1

Methods for Determining the DLI

As previously described, the present invention includes a method for determining a DLI (drug like index) for prioritizing molecules according to their drug like properties. This Example describes illustrative, non-limiting methods according to the present invention for determining the DLI. It should be noted that these methods are preferably used statistically, to determine the differential DLI for partitioning or clustering a plurality of molecules. The minimum/maximum and optimum numbers are determined statistically, depending upon such factors as the size of the database and the characteristics (drug-like vs. non drug-like) of the molecules in the database. For example, as the database is larger, the higher is the chance to obtain drug-like molecules among the best fraction of molecules.

Methods

The stochastic algorithm for distinguishing between drugs and non-drugs according to the present invention presents a new approach to this problem. In addition to constructing a “best filter” for evaluating each single molecule's potential to become a drug or not, it also enables the formation of a large set of “good filters” that are alternatives to the optimal solution, each of them being somewhat less successful than the optimal solution for determining the drug-like property on its own. The efficiency of discrimination is increased in general by employing a “combined filters approach”, which results in constructing the DLI. It is based on the assumption that an “excellent drug” (ie one having more of the desired drug-like qualities) would pass more of the “filters”, while a “useless drug” (ie one lacking such drug-like qualities) would be one which passes a minimal number of filters. This assumption is the basis for constructing the molecular DLI, which is composed of a number of contributory factors, among them, the contribution of the number of filters passed by a molecule to that molecule's overall “drug-like” quality. This approach of using combined filters partitions the set of molecules into those molecules that have a higher chance (statistical likelihood) to be a drug and others with a lower such chance.

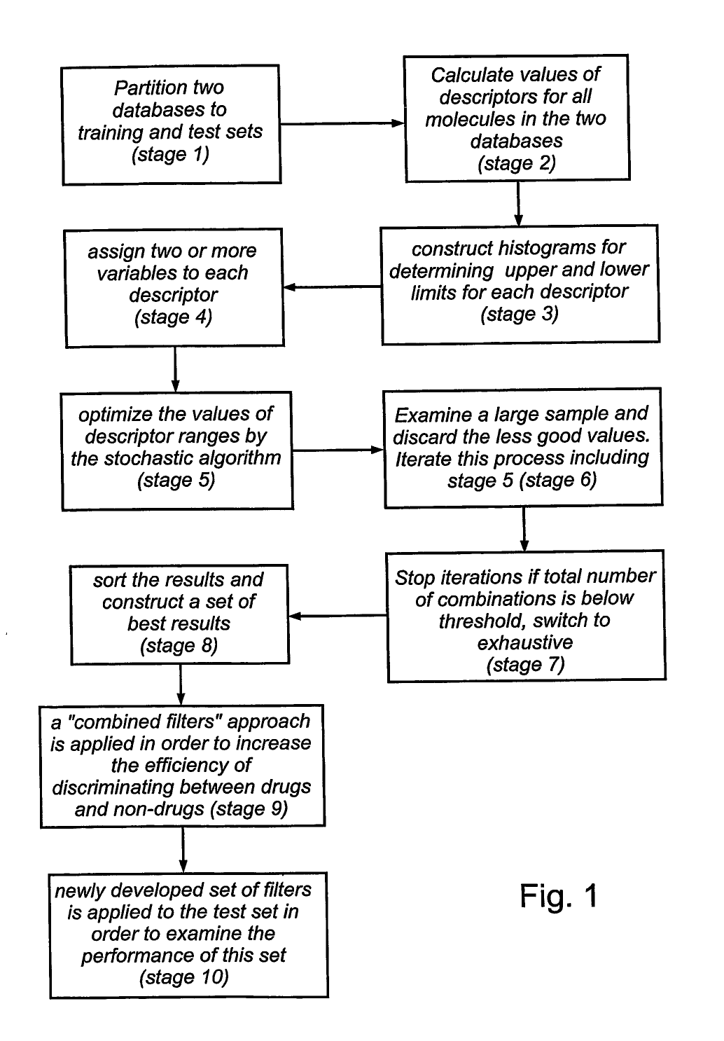

The new exemplary, illustrative approach for the prediction of drug likeness according to this Example of the method of the present invention is presented schematically below (FIG. 1). Its performance has been demonstrated with a training set and with a test set. Some of these results are also compared with those of others. Some future guidelines for further development of the approach are also suggested after discussing the results obtained to date.

Turning now to the drawings, a flowchart of some illustrative, exemplary basic processes for differentiating between “drugs” and “non-drugs” on the basis of given descriptors is given in FIG. 1. In somewhat more detail the stages are as follows:

In stage one, the two databases of drugs and non-drugs are each partitioned into a training set and a test set. Preferably, this stage is performed a plurality of times, more preferably each time more information is received about drugs and non-drugs (representing an update to the database). The quality of the databases may be expected to improve statistically because of the increase in size.

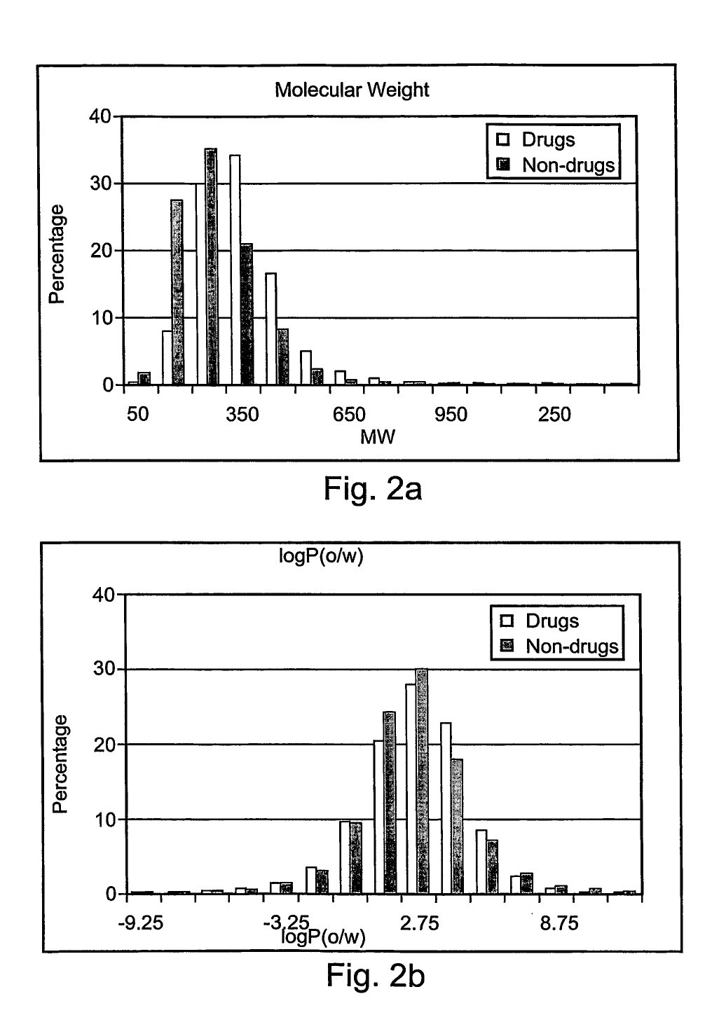

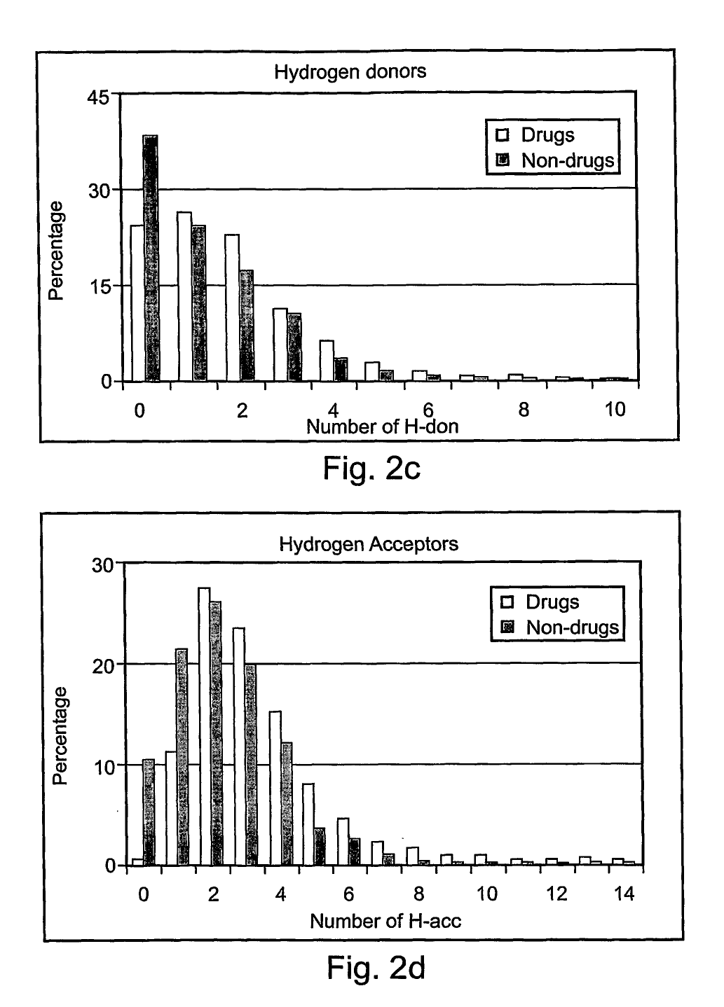

Next, in stage two, calculate the values of the physicochemical descriptors of interest for all the molecules in the two sets, using appropriate software. This stage is explained in more detail in Example 2 below. In stage three, histograms of the descriptors are optionally and preferably constructed. The histograms are preferably constructed for both data sets, drugs and non-drugs, and represented for each of them. Results are shown in FIG. 2. These histograms plot the fractions of molecules from each database (drug or non-drug molecule databases) as a function of the values of various characteristics. Therefore, they enable populations of molecules to be more readily and rapidly characterized according to these values, as well as providing a visual representation of the characteristics of the overall population.

Briefly, in FIG. 2, each histogram includes the values for CMC database and for the ACD database. All histograms are normalized. FIG. 2a presents the distribution of molecular weights in the drug and non-drug databases. It may be seen that there are proportionately more non-drugs than drugs in the molecular weight range of less than about 250. FIG. 2B presents the calculated logP (calculated lipophilic constant, for equilibration of a molecule between n-octanol and water). Again, it is possible to detect regions of lipophilic values in which drugs are more prominent, and others in which they are less prominent. FIGS. 2C and 2D present, respectively, hydrogen bond donors (all OH and NH groups) and hydrogen bond acceptors (all O and N atoms). The prevalence of one kind of molecule over another (drugs and non-drugs) may be seen in some parts of the “property space” of these two H-bond types.

Histograms are preferably performed in order to extract the values for the lower limit and the upper limit of each descriptor for at least the drug database, and then to divide it to bins. This procedure is preferably used to result in a more efficient assignment of variable (descriptor) values. Construction of a histogram is performed by introducing the values for a descriptor in a particular database (such as logP values in the ACD database) and determining the upper and lower limits of that descriptors, which are then used as the limits for computing 10-100 bins, equally partitioned between the extremum values. FIG. 2 was produced in that manner, for ACD with ˜6300 molecules and for CMC, with ˜5300 molecules, by taking the values of 4 descriptors, Molecular Weight (FIG. 2A), FIG. 2B, Calculated logP; FIG. 2C, number of H-bond donors and FIG. 2D for H-bond acceptors. These histograms have been produced by standard software (Microsoft Excel) and are important for demonstrating that it is not possible to distinguish easily between the two databases on the basis of the spread of such descriptors in single histograms.

In stage four, a plurality (preferably two) variables is assigned to each physicochemical descriptor, one for the lower limit of its range of values, and the other for the upper limit. Each range is composed of a set of discrete values.

In stage five, a stochastic search is applied for optimizing the values of the upper and lower limits of all descriptors at once. Optionally and preferably the Matthews correlation coefficient is used as the scoring function to measure the ability to differentiate between drugs and non-drugs in the training set. One of its strengths is the ability to consider true/false positives as well as true/false negatives in calculating the scoring for drugs and non-drugs, based on their database (drug or non-drug) origin and on the current rules to predict if a molecules belongs to one database or to the other. True positives are drugs from a database of drugs that are identified as drugs. False positives are non-drugs from a non-drugs database that are identified as drugs. False negatives are drugs from a drugs database identified as non-drugs, and true negatives are non-drugs from a non-drugs' database, identified as non-drugs.

Stages five and six are described in greater detail in the Example below.

In stage six, values are optionally and preferably discarded that consistently do not contribute to the optimization of the system (ie—are “less good” values). Briefly, in this process, values of the lower or upper range of a variable may be identified as contributing to results with the worst score function and should subsequently be eliminated. This process may optionally be used to improve the quality of the values of the descriptors with regard to their usefulness for predicting the drug/non-drug characteristics of a molecule.

In stage seven, the process of iterating and reducing the number of variable values continues, until a predetermined number of combinations, such as a set of some 10⁶⁻⁷ combinations, is achieved. Next, preferably the process is switched from stochastic to an exhaustive calculation of all remaining options (see below for a more detailed explanation of the exhaustive process).

In stage eight, the results from the optimum “best filters” are preferably partitioned (separated) from less optimum results.

In stage nine, a “combined filters” approach is applied in order to increase the efficiency of discriminating between drugs and non-drugs, by obtaining a higher Matthews correlation coefficient and/or increasing the differentiation between molecules based on the DLI scale. This process is described below in the section entitled “Combined filters and drug like index”. Briefly, rather than choosing a single filter to be used for differentiating between drug-like and non drug-like molecules, preferably a plurality of filters is used, thereby benefiting from the potentially greater discriminatory ability of a set of such filters.

Optionally and more preferably, in stage ten, as feedback to the efficiency and accuracy of the above stages, the newly developed set of filters is applied to the test set in order to examine the performance of this set.

Constructing a set of good filters (set of ranges for a given group of descriptors) requires to consider a huge number of combinations (the number of combinations to be explored increases exponentially with the number of descriptors to be considered in the optimization process). The stochastic algorithm is applied in order to avoid the need to exhaustively evaluate every set of ranges, and the method also enables the search to be extended to any other set of descriptors.

The basis for any application of the stochastic algorithm is in the definition of “variables” and “variable values” for the system to be studied. For the problem discussed here, the upper limit as well as the lower limit of each descriptor is considered to be a variable. Each such variable is represented by a set of discrete values. Thus, as an example, the four Lipinski descriptors are considered to present eight variables. Each variable has a number of possibilities as its values. As an example, molecular weight is considered at 5 unit intervals, and thus would have, for its “low limit”, some number between 75 and 300. Therefore, for this single variable, there are 46 optional values (75, 80 . . . 300). Each of the 8 ranges thus has between 10 and 100 discrete values. The number of combinations that finally had to be explored to optimize the ranges for Lipinski descriptors is 2*10¹¹.

Stochastic Construction of Filters

A single filter is constructed by picking one value for each of its “range descriptors”. In the present example of determining drug likeness with Lipinski's variables, eight such variables (for the optional but preferred four descriptors, Molecular weight, MW, calculated lipophilicity, logP, number of H-bond donors, HD and number of H-bond acceptors, HA) have to be uniquely determined in order to construct a single filter. Each of the 8 values is determined by a random number generation that selects a value out of the set of discrete values for each variable, and the constructed filter is applied to the molecules in each of the two training sets to calculate the value of the scoring function, its MCC (see “Cost function” below).

Overall, n filters Xᵢ are sampled to form the set for the statistical tests. Each filter Xᵢ is constructed by a random choice of the values for the upper and lower limits of its variables. The following is thus obtained:

X₁=(MW₁₁, MW₁₂, ClogP₁₁, ClogP₁₂, HD₁₁, HD₁₂, HA₁₁, HA₁₂), . . . , Xₙ (MWₙ₁, MWₙ₂, ClogPₙ₁, ClogPₙ₂, HDₙ₁, HDₙ₂, HAₙ₁, HAₙ₂), where MW₁₁ is a randomly selected value from the lower limit values of the molecular weight, in the first filter (the second subscript is for the filter limit, with 1 for lower and 2 for upper). Value MW₁₂ has been selected from the upper limit values of MW for the first filter. Similarly, value MWₙ₂ has been selected from the upper limit values of MW for the n^{th} filter. Once a filter was chosen stochastically, its cost function (vide infra) is computed by computing its value from the two training sets, of drugs and of non-drugs. Thus, for the randomly picked full set of filters X₁ to Xₙ a set of scores is selected, MCC₁ to MCCₙ. The total number of filters at each iteration, in the current illustrative, exemplary application, is n=10⁵. However, optionally and preferably, the total number n could be increased or decreased depending on the number of variables and variable values.

Elimination of Values

A distribution histogram Fⁿ_{C} for the filters is now constructed. Fⁿ_{C} is the set of scores of all the n samples. Cutoff points H and L are defined in Fⁿ_{C}. H contains the set of worst filters (lowest scores) while L contains a set of an optionally similar (or alternatively possibly different) size of the best ones. In the example presented here, of Lipinski's variables, the H and L sets include, each, 1000 filters. However, this number may be modified according to the total number of combinations and the number of remaining variable values in the iterations of the process.

Assume that all values of each of the 4 variables are equally probable across Fⁿ_{C}, i.e., there is no preference for any particular value. Under this assumption, Iₖₚ, the number of times that value k of variable p is expected to appear in the H and L sets is given by Iₖₚ=1000/Nₖₚ where 1000 is the number of filters in H and L, and Nₖₚ is the current number of values for variable p. Nₖₚ changes along the iterative process, and so is also Iₖₚ. For example, if we have 10 values for the lower limit of HD, its Iₖₚ=100 and, in the H or L sets, each of the HD values should thus appear about 100 times. This expectation value can then be used as a means to decide whether to eliminate or retain a value.

If the frequency of occurrence of value number J of, say, the lower limit of MW in L is lower than its Iₖₚ by a pre-defined amount, then value number J should be eliminated from the list of values for the lower limit of MW. That is because this particular value is found to have a low probability for contributing to the set of best (lowest scoring function value) filters in L. The “pre-defined amount” (eviction factor, EVF) depends on the user and is usually set to be between 2 and 3. EVF values were optimized in an extensive test of a problem of loop closure in protein structures, with the aim to seek a balance between computation time (which is much longer for numbers higher than 2-3) and the conservation of the best results (which may be unjustifiably discarded if EVF is a smaller number).

EVF is related to the expectation number of each variable value, Iₖₚ described above. A value that appears less than Iₖₚ/EVF in the L region (best results) would be considered for elimination. Similarly, in the H region (worst results), a value that appears more than EVF*Iₖₚ would be considered for elimination.

In a similar manner, if the abundance of a value for the lower limit of MW in the H set is larger by a certain factor than its expectation value, this value is marked for removal and its abundance in L is tested. The value will be removed if its abundance in L is smaller than its expectation value by any amount. Thus, a value for the lower limit MW will be discarded only if it fulfills the demands either in L alone, or in both H and L. There are therefore EVF values for the L region (EVF^{L}) and for the H region (EVF^{H}), separately.

The existence of too low (in L) or too high (in H) abundance of variable values is tested for all the remaining variable values at the end of each iteration based on the sample size of n filters. Thus, several values of each variable may be discarded at each iteration. The number of values is thus reduced, and the total number of possible combinations for the whole system is becoming smaller. The above stages are repeated for the reduced set of values, until the number of combinations of the system becomes smaller than a predefined “threshold”, which marks the end of the stochastic stage. From that point on, a full exhaustive search is conducted with all possible remaining combinations of variable values.

Exhaustive Stage

Once there remain about M≦10ⁿ combinations (with the value of n optionally and preferably, but not necessarily, falling between 6 and 7), an exhaustive search is preferably performed for all remaining combinations (as described above) and the resulting filters are sorted based on their MCC score. Sorting may be done by defining the maximum number of best filters, or by an MCC threshold, or by some other criterion.

The Cost Function

The optional but preferred cost function is presented in terms of the Matthews correlation coefficient:

$$DLI = \frac{{\sum }_{i = 1}^{n} {δ}_{Di} \frac{{P}_{Di}}{{P}_{NDi}} - {δ}_{NDi} \frac{{N}_{NDi}}{{N}_{Di}}}{n}$$

$$DLI = \frac{{\sum }_{i = 1}^{n} {δ}_{Di} \frac{{P}_{Di}}{{P}_{NDi}} - {δ}_{NDi} \frac{{N}_{Di}}{{N}_{NDi}}}{n}$$

P and N are the number of true positive and true negative predictions while P_{f} and N_{f} are the number of false positives and false negatives, respectively. The best possible value for C is 1.0 (for a perfect prediction P=total number of drugs in the drugs database and N=total number of non-drugs in the non-drugs database while P_{f}=N_{f}=0) and the worst possible value is −1.0 (a completely erroneous prediction, with P=N=0 and P_{f}=the total number of non-drugs, N_{f}=total number of drugs). Each molecule i can be counted in one of only two possibilities. If it is a drug molecule (i.e., it belongs to the “drug database”), it can either be counted as a “positive” (P) or as a false negative (N_{f}). It will be positive if all four of its values (MWᵢ, ClogPᵢ, HAᵢ and HDᵢ) are between those that were picked randomly as the upper and lower limits of these four descriptors. If not, it will be counted as a false negative. For molecules of the non-drug database, those can be counted as being negative (if correctly identified as non-drug, i.e., having at least one of their four values outside the range that was picked randomly) or false positive, if all their four values are between the randomly picked ranges.

Combined Filters and Drug Like Index

By using a set of filters rather than a single one (the “best” filter), the method benefits from a larger set of good filters, in order to increase the ability to differentiate between drugs and non-drugs, as well as to prioritize molecules in virtual screening databases for drug activity and in any other situation in which such prioritization is needed. Equation 2 is employed for calculating the drug-like index (DLI) and may optionally include as many of the “best filters” as desired. As the DLI for a certain molecule is larger, the confidence that this molecule could be a drug is greater. The higher the DLI cutoff that is selected, the fewer drug molecules will “pass” this cutoff. The lower the DLI cutoff, more drug molecules pass but also more non-drug molecules. The optimal cutoff is then preferably sought, by which more drug molecules and fewer non-drug molecules pass. For example, when being used with high-throughput screening (HTS), the process may optionally and preferably begin by testing molecules with higher DLI. This is described in Example 4 below. This approach of prioritizing molecules in large databases could save time and money.

DLI is composed by combining the “successful rate” or “efficiency” of prediction of drugs with a “failure rate” or “inefficiency” of prediction, for each molecule at each filter. This is given by equation 2:

$$C = \frac{( PN ) - ( {P}_{f} {N}_{f} )}{\sqrt{( N + {N}_{f} ) ( N + {P}_{f} ) ( P + {N}_{f} ) ( P + {P}_{f} )}} \qquad ( 1 )$$

In equation 2, the drug like index for a molecule is determined on the basis of a set of n filters. The number n can optionally be a number ranging from a few to thousands. The value of the delta function δ_{Di} is 0 (Zero) if the molecule is a non-drug according to the currently calculated filter i, and 1 if it is a drug according to that filter. Similarly, the value of the delta function δ_{NDi} is 1 if it is a non-drug according to the currently calculated filter, and 0 if it is a drug according to that filter. P_{Di} is the percentage of drugs that are predicted to be “drugs” according to filter i (“True positives”), while P_{NDi} is the percentage of false positives, i.e., non drugs that are predicted to be drugs according to filter i. N_{Di} is the percent of drugs identified to be non drugs according to the current filter (“False negatives”), and N_{NDi} is the percent of non-drugs identified as such by the current filter, i.e., “True negatives”. The quotient P_{Di}/P_{NDi}, may be regarded as an “efficiency factor” of filter i for the drugs, while the quotient N_{Di}/N_{NDi} is an “inefficiency factor” for misidentifying non drugs.

### Example 2

Stochastic Selection of Best Sets of Descriptors

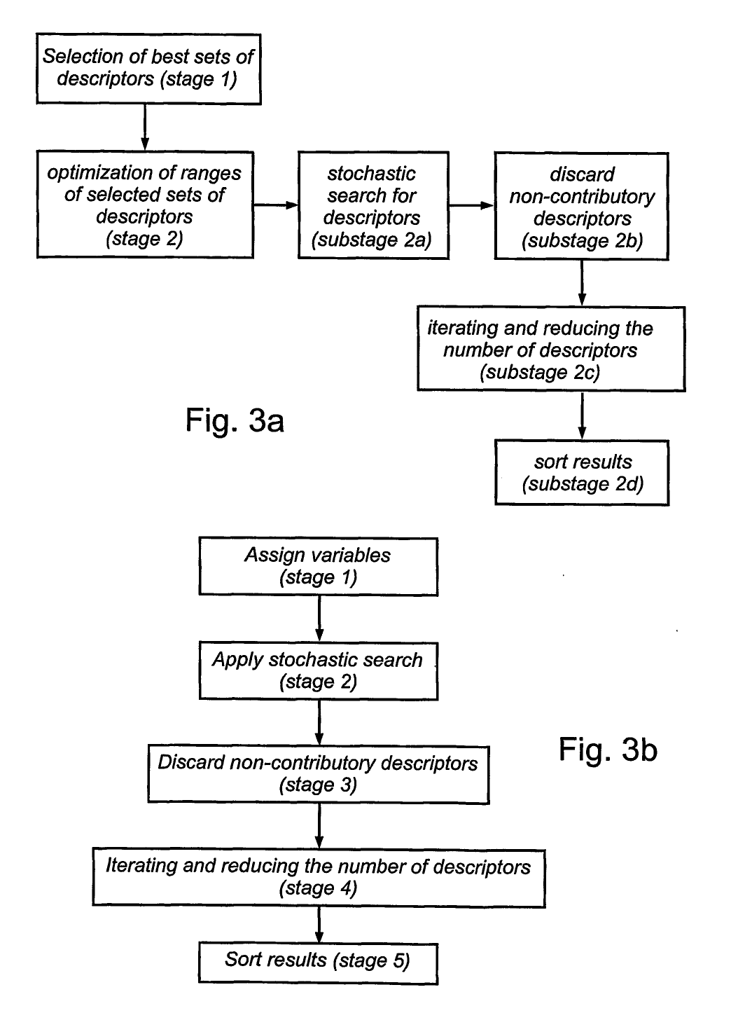

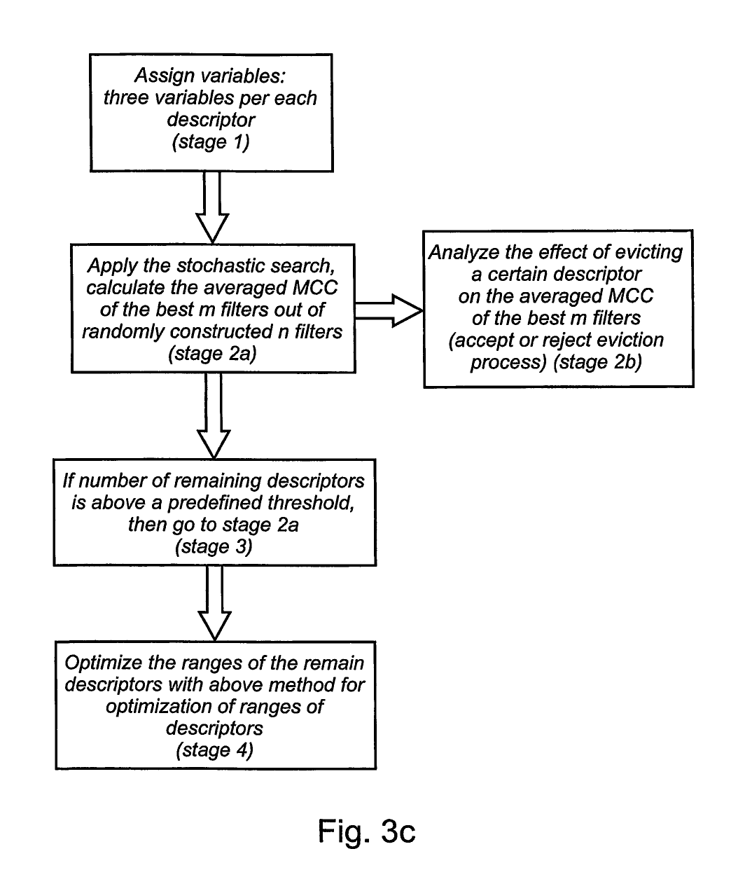

This Example describes three different exemplary, illustrative versions of methods for selecting the best sets of descriptors. The first method preferably features two stages, a first stage to select the best sets of descriptors and a second stage to select the best ranges. In the second method, preferably both aspects of the variables are optimized simultaneously. The third method is faster than the two others, and is based on iterative elimination of descriptors (FIG. 3C).

In the first method (shown with regard to FIG. 3A), stage 1 is used for selection of best sets of descriptors (with a predefined range for each descriptor, which is determined in a prior examination of many alternative ranges for a single descriptor and testing the ability of each range to act as a “filter” that would distinguish drugs from non-drugs, as judged by the cost function, the MCC, of equation 1) while in the second stage ranges of selected sets of descriptors are optimized, with a certain set size (i.e., the best 5-descriptor selection including their ranges for example, etc.).

In stage 1, each physicochemical descriptor is preferably assigned a predefined range of values. The range for each descriptor could be the range of 100% drugs or 90% drugs or any other range, whether selected by the user or optimized, in terms of its ability to discriminate effectively between drug and non-drug like molecules. Optionally and more preferably, if narrowing the range of any certain descriptor could discard more non-drugs than drugs, this new range is preferably considered for further evaluation. The discarded percentage of drugs in any range of any descriptor is preferably not higher than 10% or other threshold defined by the user. The different ranges of certain descriptors could be evaluated by computing the MCC and selecting the best MCC while the true positives percentage is higher than a predefined threshold.

Stage 2, optimization of ranges of selected sets of descriptors preferably comprises the remainder of the process, and is divided into substages for the sake of clarity and without intending to be limiting in any way.

In substage 2a, for a predetermined number of descriptors, n (n≠1}, a stochastic search is preferably applied for selecting the best sets of n descriptors, optionally and preferably by using the Matthews correlation coefficient as the scoring function to measure the ability to differentiate between drugs and non-drugs in the training set.

In substage 2b, descriptors that consistently do not contribute to the optimization of the system are preferably discarded.

In substage 2c, the process of iterating and reducing the number of descriptors is continued, preferably until a predetermined number of combinations, such as a set of some 10⁶⁻⁷ combinations, is achieved. At this point, preferably the process is switched from a stochastic to an exhaustive calculation of all remaining options.

In substage 2d, the results are sorted, preferably from the optimum “best filters” up to less optimal results. The filter in this case is preferably the selected set of descriptors, with their predefined ranges that were selected in stage 1. Its performance in differentiating between drugs and non-drugs could be improved by optimization of ranges as described above.

In the second method, described with regard to FIG. 3B, selection of best sets of descriptors and determination of optimized ranges for each descriptor is performed simultaneously.

In stage one, a plurality (preferably three) variables are assigned to each physicochemical descriptor. For the preferred embodiment of three variables, one variable is for the lower limit of its range of values, the second variable is for the upper limit while the third variable preferably has just two values, of 0 or 1, for each descriptor. This third variable could also be a digital number between 0 and 1 such as 0.1, 0.9 etc. in order to refine the different contributions of each descriptor to the differentiation between drugs and non-drugs.

In stage two, a stochastic search is preferably applied for selecting the best sets of n descriptors with optimized ranges, more preferably by using the Matthews correlation coefficient as the scoring function to measure the ability to differentiate between drugs and non-drugs in the training set.

In stage 3, descriptors and/or descriptor values that consistently do not contribute to the optimization of the system are preferably discarded, as for the method described above with regard to FIG. 3A.

In stage 4, the process of iterating and reducing the number of descriptors and the number of values for the upper and lower limit of each descriptor until a predetermined number of combinations, such as a set of some 10⁶⁻⁷ combinations, is achieved. Preferably, after this point, a switch is made from stochastic to an exhaustive calculation of all remaining options.

In stage 5, the results are preferably sorted from the optimum “best filters” up to less optimal results.

In the third method, the stochastic algorithm is initially applied to all descriptors and their ranges: the descriptors are variables, and the endpoints of their ranges are the values (upper and lower range values). In each sample, the upper limit of a descriptor is picked at random out of the list of values for that upper limit, and the lower limit is picked randomly out of the list of values for the lower limit. This random choice is repeated twice for each descriptor (once for upper limit and once for lower limit) and once all values are chosen, a single filter is fully constructed and all molecules in the databases may be examined as “drugs” (which must pass all the filters) or “non-drugs” (which fail one or more filters). This is considered to be a single sample. Once a large number of samples, M, has been collected (M is preferably in the range of 10⁵-10⁶), the method focuses on the best samples, preferably 10³-10⁴ samples (the “best samples” are those with the largest MCC). The average MCC for this set of “best results” is preferably calculated, followed by examining the MCC value with the same set of filters less one: each descriptor in its turn is evicted from the computation, and the average is re-computed without that single descriptor. Those descriptors whose eviction results in a larger average MCC are considered not to be helpful for the distinction between drugs and non-drugs and are thus preferably completely eliminated from the set of descriptors, and the ranges for all of the others are “reset”, i.e., all ranges are accessible. This iterative eviction of descriptors optionally and preferably continues up to a threshold after which a predetermined number of descriptors remains, or alternatively and preferably until the value of MCC converges and does not change with further elimination of descriptors.

An exemplary, illustrative implementation of this method is described with regard to FIG. 3C. In stage 1, assign variables, three variables per each descriptor. In stage 2a, apply the stochastic search and calculate the averaged MCC of the best m filters out of randomly constructed n filters. In stage 2b, analyze the effect of evicting a certain descriptor on the averaged MCC of the best m filters (accept or reject eviction process). In stage 3, if number of remaining descriptors is above a predefined threshold, then return to stage 2a. In stage 4, optimize the ranges of the remaining descriptors using the previously described method for optimization of ranges of descriptors.

As a nonlimiting Example, consider the following. Using the previously described approach, select the best set of four descriptors to discriminate between drug and non-drugs (CMC/ACD training sets). The set of descriptors to be searched is 15 descriptors of energy: (<E>, <E_ang>, <E_ele>, <E_nb>, <E_oop>, <E_sol>, <E_stb>, <E_str>, <E_strain>, <E_tor>, <E_vdw>, <E_rele>, <E_rnb>, <E_rsol>, <E_rvdw>)

Four descriptors out of the fifteen descriptors have only one value and are discarded prior to the stochastic search (first four descriptors in Table 1, 1-4). Eleven descriptors remain, given in Table 1 below (from descriptor number 5 and up). The last four descriptors are the optimal set of descriptors to be further optimized using the previously described method according to the present invention for range optimization (results from this stage are shown below).

TABLE 1
Remaining descriptors

| Descriptor | ID of | effect on | | |
|---|---|---|---|---|
| code | discarded | averaged | averaged | descriptors |
| (MOE) | descriptor | MCC | MCC* | discarded |
| <E_rele> | 111 | | | 1 |
| <E_rsol> | 113 | | | 2 |
| <E_rnb> | 112 | | | 3 |
| <E_rvdw> | 114 | | | 4 |
| <E_sol> | 105 | 0.02 | 0.305 | 5 |
| <E_nb> | 103 | 0.02 | 0.340 | 6 |
| <E> | 100 | 0.01 | 0.367 | 7 |
| <E_strain> | 108 | 0.008 | 0.381 | 8 |
| <E_oop> | 104 | 0.005 | 0.393 | 9 |
| <E_vdw> | 110 | 0.004 | 0.401 | 10 |
| <E_ele> | 102 | 0.002 | 0.407 | 11 |
| | Remaining | | | |
| | four | | | |
| | descriptors | | | |
| <E_ang> | 101 | | | |
| <E_stb> | 106 | | | |
| <E_str> | 107 | | | |
| <E_tor> | 109 | | | |

*The quality of the averaged MCC of the best set of filters is improved by moving from one stochastic cycle to another, due to discarding descriptors which contribute negatively to the discriminative power (MCC), as well as reducing the complexity of the search space by lowering the number of combinations and enriching the remaining space by good filters.

The best filter obtained by optimizing the ranges of the best set of four descriptors is: (<E_ang>, <E_stb>, <E_str>, <E_tor>)
MCC=0.432
TP=75.5
TN=67.7

The best filter obtained by optimization of ranges for all descriptors of energy (15 descriptors) is:
MCC=0.433
TP=72.5
TN=70.9

In conclusion, a set of four descriptors has been selected by which it is possible to obtain the same efficiency to discriminate between drug/non-drugs as obtained by employing the entire set of 15 descriptors.

### Example 3

Methods for Prioritizing Molecules for High Throughput Screening

According to an illustrative, non-limiting application of the method of the present invention, the DLI may be used for prioritizing molecules in large datasets of molecules for High Throughput Screening (HTS). In general, pharmaceutical companies test large databases of molecules composed of hundreds of thousands of compounds against certain biological target seeking hits or leads. These large databases are sometimes purchased from companies that specialize in constructing libraries of chemicals that have biological properties (which may be called “drug like molecules”). An example of such company is Timtec Inc. (http://www.timtec.net/products/targeted_libraries.htm) or AsiNex (http://www.asinex.com/) and there are many others. The purchased libraries of compounds are applied by robots to hundreds of thousands of wells on several types of “chips”, as an example of an illustrative type of biological, in vitro assay. An example is given in (http://www.rci.rutgers.edu/˜zylstra/htsfacility.html). The large databases that have to be purchased are expensive, and experiments are time consuming and are expensive as well. Some companies have the proper facilities and knowledge to construct the molecular libraries in house, by processes of combinatorial chemistry or other. A background description of some of the main issues of combinatorial chemistry may be found in (http://www.combichemlab.com/website/files/CombiChem_Links/combichem_links.htm). Briefly, a CombiChem (Combinatorial Chemistry) library is usually constructed for the sake of High Throughput Screening. In other cases, pharmaceutical and other companies maintain an in-house catalog or registry of their own molecules, which typically have been synthesized over a long period of time.

The proposed DLI term allows the size of libraries to optionally and preferably be reduced to a set of molecules which have a higher drug like index (DLI), thereby saving time and money. The fraction with higher DLI features molecules that are enriched with drug-like molecules (this is shown schematically in FIG. 6) and as the DLI threshold is lowered, the drug-like molecules will be less concentrated in subsequent fractions (portions) of the database. Prioritizing molecules for HTS is also useful in smaller pharmaceutical companies and in start up companies that have a biological target but lack small molecule drug candidates. Those companies cannot afford huge database screening, but employ smaller libraries, up to the range of about 200,000-300,000 molecules. The present invention also enables such libraries to be used in an effective manner.

In FIG. 6, an exemplary method is shown as follows. In stage 1, a large library of molecules is provided. In stage 2, these molecules are selected according to the method of the present invention, preferably according to the DLI. It should be noted that selection may optionally comprise prioritization. Selection and/or prioritization is preferably determined according to a minimum value or threshold for the DLI. Next, in stage 3, the selected molecules (optionally according to their priority) are used for the high throughput assay (optionally any type of assay may be used, such as a biological assay as previously described for example, and could easily be selected by one of ordinary skill in the art). This set of molecules is much smaller than the original set and therefore may be examined more efficiently.

If the method of the present invention is to be used for combinatorial chemistry in combination with a high throughput assay, which may be optionally done, then preferably the DLI is used to prioritize scaffolds and/or their substituents for creating molecules for the high throughput assay.

As an example, which is provided for the purpose of description only and without any intention of being limiting in any way, the application of DLI (equation 2 above) to relatively large databases selected from the full MDDR, ACD and CMC databases was examined. These sampled databases were separated into training sets and test sets. Each of the databases were “cleaned” to include molecules that have “biological relevant atoms” (C, H, N, O, P, S, Si, halogens) and to eliminate duplicates entries and entries that lack structure as well as compounds of undesired classes as described for example in (Ajay, Walters et al. 1998; Ghose, Viswanadhan et al. 1999; Xu and Stevenson 2000; Muegge, Heald et al. 2001). Structures of counterions and solvents were then removed. All molecules were preferably and preferentially “energy minimized” to include partial charges, for example by using the MOE software (http://www.chemcomp.com/). Molecules in the “biological testing” category of MDDR were preferably eliminated, so that only molecules in preclinical and clinical testing remained, as these molecules are expected to be more drug-like. All of these stages may optionally be described as pre-processing or “cleaning”; also optionally, all stages or a selected sub-set thereof may optionally be performed. The training sets featured CMC, 3990 molecules, MDDR, 5786 molecules and ACD, 4764 molecules. The test sets featured, respectively, 1329, 1928 and 1588 molecules.

Filters for the construction of DLI were preferably obtained, in this example, from applying the third method for choosing the best set of descriptors by differentiating between CMC and ACD, and constructing a set of some 200 filters from, for example, 11-descriptor filters, 4-descriptor filters etc. The highest expected MCC values were 0.57 for a filter of 11 descriptors that are presented in Table 2 below, while other filters had smaller MCC values. The initial filters underwent a clustering process, in which filters that are 2-4% similar to others were not included in the set of filters for computing the DLI. Results for the DLI values in each of the databases are presented in the results section. The DLI values, computed on the basis of differentiation between ACD and CMC, were applied to MDDR or parts of it, as well as to the test sets of CMC and ACD. Some results of average DLI were, for example: CMC: 1.86; ACD: 0.29; MDDR: 1.99, Phase I, 2.05; etc.

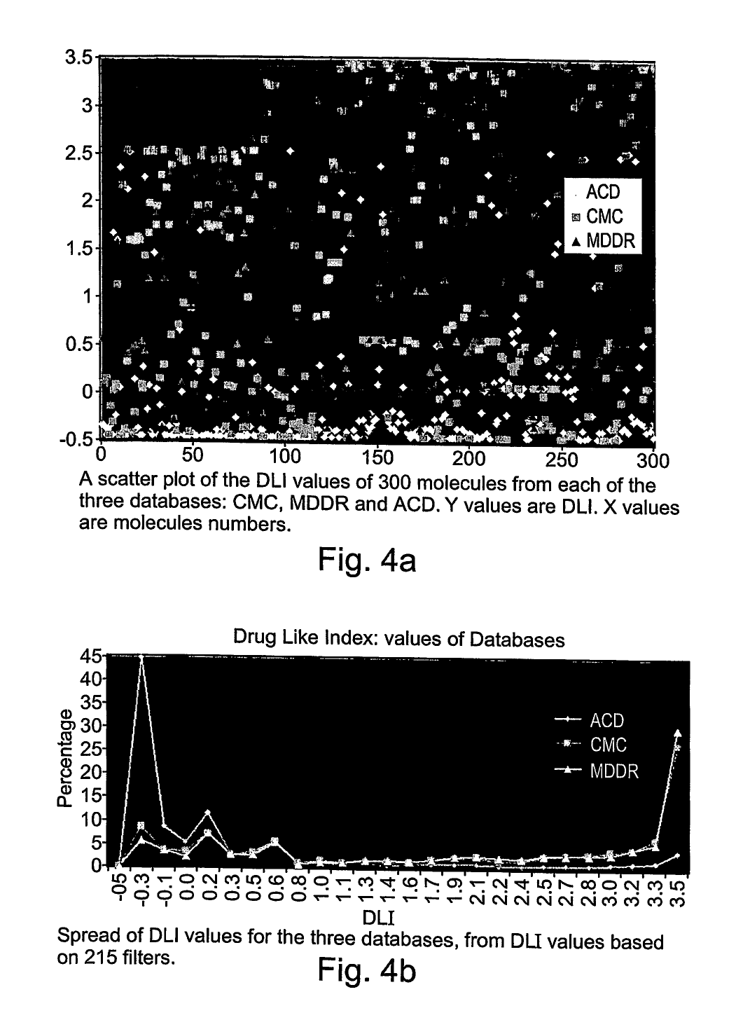

Results for the full databases are shown in FIGS. 4A and 4B. In FIG. 4A, 300 molecules from each of the databases have been displayed, with their DLI values. This figure demonstrates that DLI values for ACD molecules are lower than those of CMC and MDDR, and that MDDR values of DLI are somewhat higher than those of CMC, by a small amount. In FIG. 4B, the full values for the test sets of MDDR, CMC and ACD are shown. Most of the ACD values are in the lower range, while a few are in top DLI values. CMC and MDDR clearly have much larger DLI values.

The extension to larger databases may easily be made as follows. Once a set of filters has been determined by applying the iterative stochastic algorithm to databases of drugs and of non-drugs, it is possible to apply these results to the computation of large and very large sets of molecules, for which descriptors may be calculated. Each molecule in the database is examined in each of the filters, and its values for equation 2 are determined without having to know if it is a real drug or not, while allowing its DLI to be calculated. If it passes a filter, the first “efficiency factor” P_{Di}/P_{NDi} will be computed for it. If it does not pass the filter, it is judged to be a non-drug, and the “inefficiency factor” N_{Di}/N_{Ndi} will be determined for it. Once a molecule has passed all the filters, its DLI may be finally computed. In that manner, the values for many molecules may be computed by applying the filters that were previously constructed.

### Example 4

Methods for Constructing Lead Molecules by the Addition of Substituents

A lead molecule is one that is active against a certain biological target but needs to be improved for its drug properties. Such improvement is performed generally by addition of substituents in certain positions on the lead molecule, most commonly by replacing hydrogen atoms by organic moieties or an organic moiety by another one which has required properties. Such additions are expected to improve the drug properties of the molecule as well as its biological activity, or at least to not harm the biological activity.

Starting from the lead molecule which is considered to be a “core” or a “scaffold”, a large database of molecules is constructed in silico. In this process, the variables are optionally and preferably selected hydrogen atom positions on the lead molecule because they are the ones to be “substituted” by “substituents”, and their values are a database of substituents. For many molecules, some 3-6 alternative substitution positions may be expected because most scaffolds contain such a number of substitution positions, and each position could optionally have a few hundred substituents. If 4 hydrogen atoms are to be possibly “mutated” into substituents and the database of substituents is composed of 100 moieties only, then a virtual database of molecules composed of 100⁴=100,000,000 molecules can optionally be constructed.

This set could optionally and preferably be optimized, by applying the stochastic algorithm with the scaffold substitution positions as variables and with substituents as values. A “stochastic molecule” is constructed, one in which all substitution positions are “filled” randomly by the algorithm, after which its DLI may optionally and preferably be evaluated. This process is optionally and preferably repeated a plurality, and more preferably many times, to construct a large number of such molecules, which constitutes a sample. The sample is preferably sorted according to the DLI values of the molecules, and preferably at least one statistical analysis tool (described above under “elimination of values”) is applied in order to evict substituents in each of the substitution positions. The process preferably continues in a plurality of iterations, which more preferably terminate once a threshold number of substituents have been discarded in each of the substitution positions and/or the total number of combinatorial possibilities has been reduced to a pre-determined number. Optionally, the threshold number of substituents may be a number that is large enough to permit the total number of combinatorial possibilities to be reduced to a pre-determined number. An exhaustive computation of the DLI values for all remaining substitution combinations is then preferably performed and the results are sorted.

In the absence of a known 3D-structure of the target, the fraction with higher DLI could be synthesized and tested experimentally or, it could be combined with virtual docking, if the 3D structure of the biological target is known.

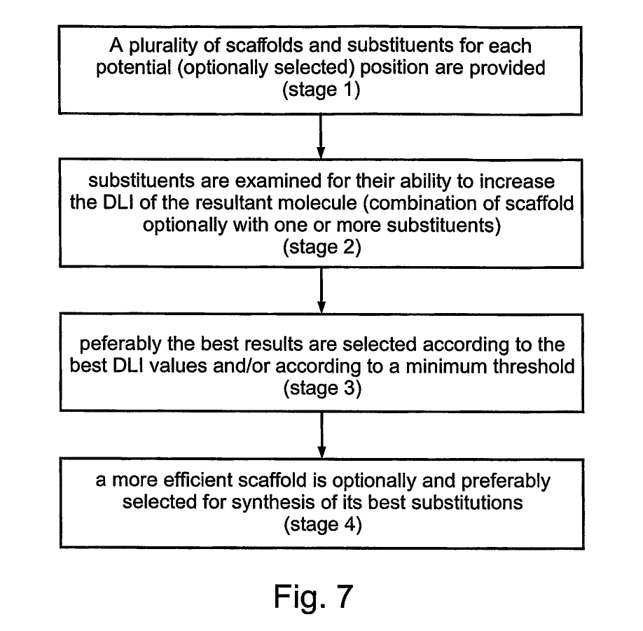

FIG. 7 shows an exemplary method according to the present invention for such a combination of scaffold examination by virtual substitutions with the selection/prioritization method according to the present invention. As shown, in stage 1, a plurality of scaffolds and substituents for each potential (optionally selected) position are provided. In stage 2, substituents are examined for their ability to increase the DLI of the resultant molecule (combination of scaffold optionally with one or more substituents). In stage 3, preferably the best results are selected according to the best DLI values, and/or according to a minimum threshold. In stage 4, a more efficient group of molecules is optionally and preferably selected for synthesis, or for development of hits into leads, based on a plurality of hits that emerge from a previous high throughput screening assay or any other assay.

### Example 5

System and Method for Combining Docking and the Present Invention

As noted above, docking is a method of modeling the binding of a ligand (such as a drug molecule for example) to a target (such as a protein for example). It has been used to model the binding of a potential drug candidate to a receptor, for example, or other target. Although it may provide very useful information on a molecular level concerning the interactions between a ligand and target pair, it has a number of disadvantages. In particular, as noted above, docking cannot provide any information concerning the possible absorption of the drug by the body and/or bioavailability.

According to this exemplary embodiment of the present invention, it is possible to combine docking with the method according to the present invention. The scoring function could for example optionally be a combination of the DLI of the molecule and of its binding energy to the biological target. By this strategy, good binders (ie molecules that bind well to the target) which are not-drug like molecules could be evicted as they are not useful, as well as molecules that have a low DLI. According to preferred embodiments of the present invention, the DLI is preferably applied to the results of virtual docking of many molecules, for those molecules that passed the affinity test. There is a tendency to experimentally examine molecules that were successfully docked in virtual screening, while the addition of the DLI criterion could limit that practice to a smaller number of molecules whose DLI is at an appropriate level.

Virtual docking has become an important method for examining the ability of molecules to bind to their targets, if the structure of the target is known. This is the source of difference between the present example and the previous ones, Examples 3 and 4 above, in which no knowledge of the structure of the biological target is necessary. In the present example, docking of a “virtual library” is performed initially by one of the known methods for such docking (Bissantz, Folkers et al. 2000; Paul and Rognan 2002) and the results are sorted by their “virtual affinity” which hopefully expresses the order of true affinities, at least for most of the molecules. The highest affinity molecules may then form the “input set” for computing DLI. Thus, DLI will be applied only to the molecules that are supposed to bind better to the biological target. In that manner, it is possible to “cover” both the pharmacodynamic aspect of drug interactions (by the docking) as well as the pharmacokinetic aspect.

Also according to the embodiments of the present invention, a reversal of this process may optionally be performed, in which the whole “virtual library” (Langer and Krovat 2003; Schapira, Abagyan et al. 2003; Watson, Verdonk et al. 2003) is examined for its DLI values prior to the docking, and only the molecules above a certain DLI undergo the docking experiment. This is preferred if the docking of each molecule requires longer CPU time, and thus the DLI helps decision making by prioritizing the molecules in the virtual library, as described in example 3 above. Finally, and also according to the embodiments of the present invention, all molecules in the virtual library optionally and preferably undergo both processes—docking and DLI computation, and a weighted score is produced by equation (3):
Score=C₁×DLI+C₂×Affinity (C₁≧0.0, C₂≧0.0; C₁²+C₂²=1) (3)
and the best scores are the most negative ones, because the best affinities are those with the most negative values, and the best DLI values are the most positive ones. The values of C₁ and of C₂ are preferably determined in order to keep the signs of the scores from changing and to normalize the overall values, thus giving equal chances to different C₁ and C₂ combinations to reproduce best the overall results. Different virtual libraries and different biological targets may need a different combination of C₁ and C₂ according to equation 3 above. One of ordinary skill in the art could easily select these values, and/or they could optionally be determined heuristically. However, for a particular examination of a virtual library wit a particular target, C₁ and C₂ are preferably constants for that examination.

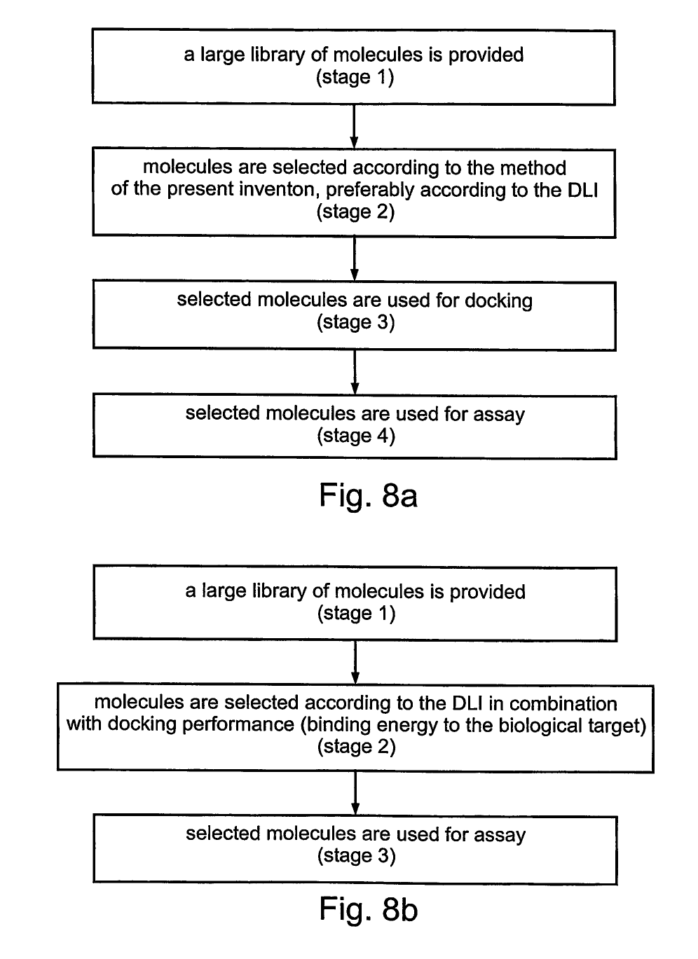

FIG. 8 shows an exemplary, illustrative, non-limiting method according to the present invention for combining the DLI with docking, with two optional embodiments, shown in FIGS. 8A and 8B.

In FIG. 8A, a large library of molecules is provided (stage 1). Next, molecules are selected according to the method of the present invention, preferably according to the DLI (stage 2). Next, selected molecules are used for docking (stage 3). Then, selected molecules are used for an assay to determine whether they have the desired activity (for example, some type of biological, in vitro assay; stage 4).

In FIG. 8B, a large library of molecules is again provided, as for FIG. 8B (stage 1). Next, molecules are selected according to the DLI in combination with docking performance (binding energy to the biological target) (stage 2). Then, selected molecules are used for an assay as above (stage 3).

### Example 6

Demonstration of the Present Invention with a Test Case

The method of the present invention was examined with actual test cases, involving the selection of an actual training set and demonstration of the efficacy of the present invention.

Selection of “Training Set” and “Test Set”

For this non-limiting, illustrative example, the CMC database is optionally employed as the drugs database and the ACD is optionally employed as the non-drugs database. The full CMC, containing initially 7375 molecules, underwent pre-processing or “cleaning” as described above, and subsequently remained with a total of 5319 molecules. Those molecules were randomly partitioned into two portions of ¾ of the molecules and ¼ of the molecules, thus providing 3990 molecules in the training set and 1329 in the test set. The ACD was divided into some 35 random sets of ˜8000 molecules each. One of these ACD random sets, with initially 7820 molecules, underwent the process of “cleaning” to produce a set of 6352 molecules. Those molecules were again partitioned into a randomly picked training set of 4764 molecules and a test set of 1588 molecules. The MDDR database was initially reduced by eliminating all the molecules with “biological testing” category, thus providing an initial set of 10482 molecules. After “cleaning”, 7714 molecules remained, out of which 5786 were picked randomly for the training set and 1928 remained for the test set. In the MDDR, a few additional divisions are possible and may optionally be performed, into a set of molecules in Phase I clinical trials (488 molecules from the final full set of MDDR), Phase II (642 molecules), Phase III (117) and launched products in the market (549).

Construction of the Final Set for the Experiments

The stochastic algorithm was applied to distinguish between the databases of CMC and ACD and also to distinguish between the databases of MDDR and ACD, for comparison. A few tables are reported below as examples for the different exemplary, illustrative, non-limiting tests. Each of the training and test databases was preferably “washed” of counterions and solvents by reading the special format (SDF format) into the software MOE (http://www.chemcomp.com/) and applying that operation with MOE. Subsequently, all molecules underwent “energy minimization” preferably with the MMFF94 force fields but possibly with other force fields. Next, preferably by using MOE but possibly in other software packages such as “DRAGON” (http://www.disat.unimib.it/chm/Dragan.htm) or in the software package of Accelrys (http://www.accelrys.com/dstudio/ds_medchem/ds_medex_property.html), descriptors were calculated for each of the molecules in the databases. In this particular non-limiting, illustrative example, 192 descriptors were calculated, which comprise descriptors of type 1D (a single number for a molecules, computed from its components etc., such as molecular weight, lipophilic character, number of atoms of several types etc.) or of type 2D (which consider the two dimensional structure, such as connectivities, molecules graphs, atomic charges etc.).

Applying the Stochastic Algorithm

The stochastic algorithm was applied to the databases which include all the 192 descriptors in this example, obtained as described above. For each descriptor, an upper range and a lower range variable was constructed. Thus, there are 384 variables from which to select in order to construct a single sampling in this illustrative, non-limiting. For each descriptor, a value for the high range and a value for the low range was picked randomly and constituted ranges for all 192 variables. These ranges are considered to be the ranges that characterize drugs, and each of the molecules in the database was “passed” through this filter of 192 ranges. If it passed all of them, it was considered to be a drug. If that “drug” is a molecule out of a drug database, such as CMC or MDDR, it is a “true positive” or P_{D}. If that “drug” is a molecules out of the ACD database, it is a “false positive” or P_{ND}. If it fails to pass a single range as a drug, it is considered to be a non-drug, and if it is originally from a drug database, it would be defined to be “false negative” of N_{D}. If it fails to pass all ranges and is from the ACD, it is a “true negative”, or N_{ND}.

Once all molecules from the two databases were processed, the total number of “negatives” and “positives” with the “true” and “false” character was determined. These numbers were fed into equation (1) for computing the MCC values. Thus, each random determination of a filter preferably ends by computing an MCC number that is based on the results for the P and N definitions. A full sample preferably includes 100,000 or more random determinations of full filters for all the ranges, and subsequently the MCC results for this large set are optionally and preferably sorted, so as to be able to concentrate on the best 1,000 results (or any other number of best results that is desired).

In this non-limiting, illustrative example, the average MCC was computed for the best results. The effect of each of the descriptors on this MCC was computed by eliminating the descriptor and its range, and recomputing the MCC. This enables a decision to be reached concerning which descriptors may be fully evicted, as described above. Once a predetermined number of descriptors has been reached, optimization of ranges is performed using the previously described method for optimization of ranges of certain set of descriptors. The obtained best filters are clustered by requiring that the filters should be dissimilar at least by x% (with x ranging between 2-10, depending on the set).

For example, assume that the total number of molecules for screening is M molecules and the cutoff for clustering is X%, then if the number of molecules identified differentially by the two filters (drugs in filter 1 are found to be non-drugs according to filter 2 or vice versa) is lower than M*X%, these filters should be placed in the same cluster, otherwise, they should be in different clusters (the filter with the highest MCC is considered to be representative of the cluster).

Results

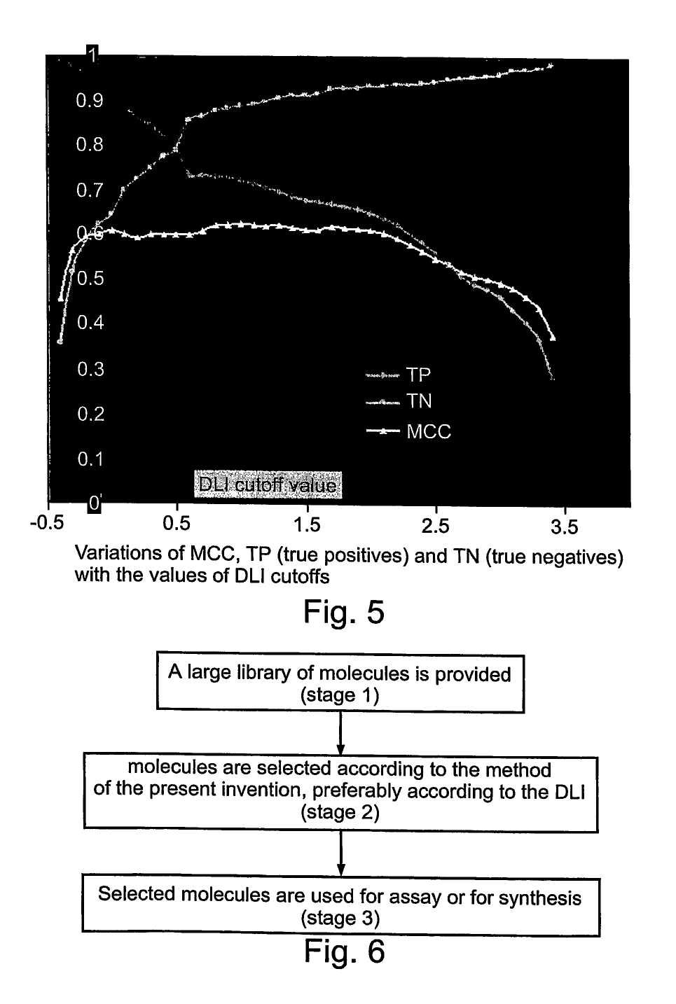

FIG. 5 shows the MCC, True Positives (TP) and True Negatives (TN) values as they change along the DLI cutoff value. At each DLI cutoff value presented on the x axis, the TP value presents the fraction of true drugs having DLI values above this threshold and the value of TN presents the fraction of true non drugs having DLI values below this threshold.

In this example, the number of variables was reduced to 11 which are given below:

TABLE 2
11 descriptors - comparison of MDDR-ACD databases
(Condition = 11 out of 11)

| Number | descriptor |
|---|---|
| 21 | <b_single> |
| 28 | <Weight> |
| 40 | <b_heavy> |
| 43 | <chi1> |
| 48 | <zagreb> |
| 49 | <balabanJ> |
| 81 | <PC-> |
| 105 | <E_sol> |
| 109 | <E_tor> |
| 134 | <a_acc> |
| 159 | <SMR_VSA1> |

TABLE 3
A few best filters for the descriptors of Table 2, their MCC
values and number of true positives and true negatives

| FILTER | MCC | TP | TN |
|---|---|---|---|
| 1 | 0.57 | 75 | 82 |
| 2 | 0.57 | 73 | 84 |
| 3 | 0.56 | 75 | 81 |
| 4 | 0.56 | 76 | 80 |
| 5 | 0.56 | 73 | 83 |

If for example, the 4 best descriptors are to be selected for MDDR and ACD, the descriptors <b_heavy>, <balabanJ>, <PC-> and <E_tor> were obtained as the best 4-descriptor set, giving a best MCC of 0.55. For CMC and ACD, the best 4 descriptors were found to be <a_IC>, <balabanJ>, <E_tor>, and <SMR_VSA1>, giving an MCC of 0.47. With an additional descriptor, <zagreb>, the MCC value for CMC vs. ACD rose to 0.48.

Computing the DLI for the Databases

Once the filters have been prepared and ordered from the highest to lower MCC values, processing of the “virtual databases” is possible. A preferred precondition is that each molecules preferably must have all its descriptors calculated prior to the computation. In this example, DLI was calculated based on 215 filters that are extracted from the CMC vs. ACD experiments on the training sets. It was then applied to the test databases as well as to the other databases that were organized. The computation of DLI is very fast for any size of database. The following values of DLI were obtained:

| | |
|---|---|
| CMC (test set) | 1.863 |
| ACD (test set) | 0.288 |
| MDDR full set | 1.997 |
| Launched drugs (into the market) (from MDDR database) | 1.716 |
| Drugs in Phase III clinical trials (from MDDR) | 1.945 |
| Drugs in Phase II clinical trials (from MDDR) | 1.978 |
| Drugs in Phase I clinical trials (from MDDR) | 2.051 |

Testing the Lipinski Variables

The ranges of descriptors were optimized, based on the 4 Lipinski variables of Molecular weight, calculated lipophilicity, and numbers of hydrogen bond donors and acceptors. Applying the “rule-of-5” with its original values gave a slightly negative MCC=−0.03 for CMC vs. ACD by applying also the Lipinski condition that a drug molecules is allowed to “violate” one of the 4 components of the rule. This is quite similar to another examination of these values by Frimurer et al. (Frimurer, Bywater et al. 2000). Strict application of all 4 components reduced MCC to a more negative value of −0.17.

In the following tables, the results for the Lipinski variables that were obtained by varying the ranges of the variables are presented. A few filters are given for each of the MDDR vs. ACD and CMC vs. ACD experiments, and compared to the values of the Lipinski original rule with the single violation condition (3 out of 4) and no violation condition (4 out of 4 conditions must be met). In these tables, the MCC value is presented for each filter, followed by the percentages of true positives and true negatives, and then by the ranges of the descriptors. For example, MW of >282˜ means that the lower limit is 282 and no upper limit is required (it is the database upper limit of Molecular Weight). HA is the number of hydrogen bond acceptors, HD is the number of hydrogen bond donors, and logP is the calculated lipophilicity.

Tables 4-7. Application of the Lipinski variables for distinguishing between drugs and non-drugs

TABLE 4
Four descriptors of Lipinski (five representative filters
after clustering) - MDDR-ACD databases (Condition = 4
out of 4) (At least 3% of total molecules convert their
sign - drug to non-drug or vice versa)

| | | | | | % D | % ND |
|---|---|---|---|---|---|---|
| MCC | MW | ClogP | HDon | Hacc | (P) | (N) |
| 0.49 | 282< | −6< | 0< | 2≦ | 82 | 67 |
| 0.49 | 292< | −2.5< | 0< | 2≦ | 78 | 71 |
| 0.49 | 292< | <9.5 | 0< | 2≦ | 80 | 69 |
| 0.49 | 301< | −6< | 0< | 2≦ | 77 | 72 |
| 0.48 | 282< | −6< | 0< | 1≦ | 85 | 63 |

TABLE 5
Four descriptors of Lipinski (five representative filters
after clustering) - CMC-ACD databases (Condition = 4
out of 4) (At least 6% of total molecules convert their
sign - drug to non-drug or vice versa)

| FILTER | MCC | TP | TN | MW | HA | HD | logP |
|---|---|---|---|---|---|---|---|
| 1 | 0.35 | 83 | 51 | >239-<1527 | >0-˜ | 0-˜ | >˜-9.5 |
| 2 | 0.34 | 90 | 41 | >213-˜ | >0-˜ | 0-˜ | >˜-˜ |
| 3 | 0.34 | 76 | 58 | >255-<1527 | >0-˜ | 0-˜ | >−3.3-7.9 |
| 4 | 0.34 | 73 | 61 | >246-<1527 | >1-˜ | 0-˜ | >˜-7.9 |
| 5 | 0.33 | 77 | 56 | >228-<1023 | >1-˜ | 0-˜ | >˜-˜ |

TABLE 6
Ranges of Lipinski - CMC-ACD databases
(Condition = 3 out of 4)

| FILTER | MCC | TP | TN | MW | HA | HD | logP |
|---|---|---|---|---|---|---|---|
| 1 | −0.03 | 92 | 7 | =<500 | =<10 | =<5 | =<5.0 |

TABLE 7
Ranges of Lipinski - MDDR-ACD databases
(Condition = 3 out of 4)

| FILTER | MCC | TP | TN | MW | HA | HD | logP |
|---|---|---|---|---|---|---|---|
| 1 | −0.17 | 82 | 7 | =<500 | =<10 | =<5 | =<5.0 |

Prioritizing Scaffolds with DLI

In this example, the basis for preferring a scaffold over another scaffold, on the basis of DLI, is demonstrated in part. Such a prioritization of scaffolds is needed in high throughput screening experiments, when many hits are found and it is required to decide which of the molecules should be further developed. One of the methods for decision can be to use their scaffolds and substitute these scaffolds virtually in order to initially prioritize the substitutions (as in example 4 above). Then, the best set of molecules is used to compute an average DLI value for that scaffold. Preferably, an equal number of best molecules for each scaffold is chosen. The scaffold with the better average DLI could be the one to develop further, if no other criterion for distinguishing between the two scaffolds exists. To test the ability to distinguish between scaffolds, a single scaffold was selected to examine whether it has better DLI values in a drug database compared to a non-drug database. The scaffold of Naphthalene is one of the common scaffolds, and has been searched in the full MDDR database and in one of the partitioned ACD databases.

More than 4,000 molecules were found in the MDDR and 1100 molecules in the ACD. The average DLI for the MDDR Naphthalene scaffold was 2.214. The average DLI for the 1100 Naphtalene derivatives in the ACD was 0.106.

### CONCLUSION

The ability of the method of the present invention to discriminate between databases of drugs and of non drugs has been demonstrated, with a stochastic algorithm that constructs “filters” that have low and high limits for each variable, thus forming a “range” of values for that variable. The ranges of a certain set of descriptors together form a “filter”. Employing the “combined filters” approach improves the ability to distinguish between drugs and non-drugs, as well as for the ability to define the Drug Like Index for each molecule in the database. If these two databases differ in two “disconnected” parts of a descriptor's full range, i.e., if the two databases differ in the smaller values and in the larger ones but are similar in the intermediate values, it is more probable that this effect will be taken care of by the “combined filters”, in which the smaller values will be covered by some filters while the larger values will be covered by others.

The extension of the same approach for distinguishing between databases of molecules that have different properties or function differently under certain conditions (such as molecules that are soluble in water and those that are not, molecules that pass blood-brain barrier and those that do not, molecules that are used as drugs for a particular disease and those that do not, etc.) is straightforward and has been demonstrated above. The cost functions are simple and exact, to the extent that experimental findings have been carefully documented. There is clearly a need for employing different sets of “descriptors” to cover the range of possibilities. Such different sets may be obtained from many resources, such as physical data tables (for solubilities, acidity constants, dipole moments etc.) or, they may be calculated by appropriate software. There are at least 4 marketed programs that can produce, for each molecule, large sets of “descriptors”, some 100-2000 of those for each molecule. The stochastic approach presented in this invention can easily be extended to have more “descriptors” (variables) as well as even include “descriptor weights”, i.e., a factor that multiplies each descriptor and that is also determined stochastically in the same sized samples and with the same eviction approach as above. Such a factor determines to what extent a descriptor plays a role in determining the property difference between databases.

The present invention may be extended and applied to any pairs of databases that may be distinguished from each other by some property. This invention is capable of distinguishing between them and able to predict the percentage of “belonging” to each database for a new and previously undetermined object, on condition that a set of common “descriptors” exists or may be formed for describing each of the objects in the databases.

The present invention therefore also encompasses selection of other sets of descriptors that could be more efficient than those of the Lipinski descriptors for discriminating between drugs and non-drugs. The best set or sets of physicochemical descriptors to be selected for further studies could be thus extracted by optimization using the stochastic approach. Each descriptor could be treated itself either as a variable with two binary values (for participation or non-participation) or with many more values.

The use of the Drug Like Index (DLI) for a few applications, such as reduction by prioritization of High Throughput Screening libraries and of Combinatorial Chemistry libraries, the combination with virtual docking experiments and the prioritization of scaffolds for developing hits to leads and leads to drugs has been demonstrated as well.

DLI is clearly a useful decision making tool for prioritizing synthesis or purchase of molecular entities, among many possible applications.

In view of the large number of possible applications and embodiments of the present disclosure it should be recognized that the illustrated embodiments are only particular examples and should not be taken as a limitation on the scope of the disclosure.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, patent applications and sequences identified by their accession numbers mentioned in this specification are herein incorporated in their entirety by reference into the specification, to the same extent as if each individual publication, patent, patent application or sequence identified by their accession number was specifically and individually indicated to be incorporated herein by reference. In addition, citation or identification of any reference in this application shall not be construed as an admission that such reference is available as prior art to the present invention.

### REFERENCE LIST

Ajay, W. P. Walters, et al. (1998). “Can we learn to distinguish between “drug-like” and “nondrug-like” molecules?” Journal of Medicinal Chemistry 41(18): 3314-3324.
Bissantz, C., G. Folkers, et al. (2000). “Protein-based virtual screening of chemical databases. 1. Evaluation of different docking/scoring combinations.” J. Med. Chem. 43(25): 4759-67.
Bohm, H. J., D. W. Banner, et al. (1999). “Combinatorial docking and combinatorial chemistry: design of potent non-peptide thrombin inhibitors.” J Comput-Aided Mol. Design 13(1): 51-6.
Brustle, M., B. Beck, et al. (2002). “Descriptors, physical properties, and drug-likeness.” Journal of Medicinal Chemistry 45(16): 3345-3355.
Charifson, P. S., J. J. Corkery, et al. (1999). “Consensus scoring: A method for obtaining improved hit rates from docking databases of three-dimensional structures into proteins.” J. Med. Chem. 42(25): 5100-9.
Clark, D. E. and P. D. J. Grootenhuis (2002). “Progress in computational methods for the prediction of ADMET properties.” Current Opinion in Drug Discovery & Development 5(3): 382-390.
Clark, D. E. and S. D. Pickett (2000). “Computational methods for the prediction of ‘drug-likeness’.” Drug Discovery Today 5(2): 49-58.
Claussen, H., C. Buning, et al. (2001). “FlexE: efficient molecular docking considering protein structure variations.” J. Mol. Biol. 308(2): 377-95.
Diller, D. J. and K. M. Merz (2001). “High throughput docking for library design and library prioritization.” Proteins: Structure, Function, and Genetics 43: 113-124.
Doman, T. N., S. L. McGovern, et al. (2002). “Molecular docking and high-throughput screening for novel inhibitors of protein tyrosine phosphatase-1B.” Journal of Medicinal Chemistry 45(11): 2213-2221.
Egan, W. J., K. M. Merz, et al. (2000). “Prediction of drug absorption using multivariate statistics.” Journal of Medicinal Chemistry 43(21): 3867-3877.
Ertl, P. (2003). “Cheminformatics analysis of organic substituents: identification of the most common substituents, calculation of substituent properties, and automatic identification of drug-like bioisosteric groups.” Journal of Chemical Information and Computer Sciences 43(2): 374-380.
Frimurer, T. M., R. Bywater, et al. (2000). “Improving the odds in discriminating “Drug-like” from “Non Drug-like” compounds.” Journal of Chemical Information and Computer Sciences 40(6): 1315-1324.
Ge, N. X., S. J. Cho, et al. (2002). “Testing non-additivity of biological activity in a combinatorial library.” Combinatorial Chemistry & High Throughput Screening 5(2): 147-154.
Ghose, A. K., V. N. Viswanadhan, et al. (1999). “A knowledge-based approach in designing combinatorial or medicinal chemistry libraries for drug discovery. 1. A qualitative and quantitative characterization of known drug databases.” Journal of Combinatorial Chemistry 1(1): 55-68.
Glick, M. and A. Goldblum (2000). “A novel energy-based stochastic method for positioning polar protons in protein structures from X-rays.” Proteins-Structure Function and Genetics 38(3): 273-287.
Glick, M., G. H. Grant, et al. (2002). “Docking of flexible molecules using multiscale ligand representations.” Journal of Medicinal Chemistry 45(21): 4639-4646.
Glick, M., A. Rayan, et al. (2002). “A stochastic algorithm for global optimization and for best populations: A test case of side chains in proteins.” Proceedings of the National Academy of Sciences of the United States of America 99(2): 703-708.
Goodsell, D. S. and A. J. Olson (1990). “Automated docking of substrates to proteins by simulated annealing.” Proteins: Structure, Function, and Genetics 8: 195-202.
Jones, G., P. Willett, et al. (1997). “development and validation of a genetic algorithm for flexible docking.” J. Mol. Biol. 267: 727-748.
Knegtel, R. M., I. D. Kuntz, et al. (1997). “Molecular docking to ensembles of protein structures.” J. Mol. Biol. 266(2): 424-40.
Knegtel, R. M. and M. Wagener (1999). “Efficacy and selectivity in flexible database docking.” Proteins: Structure, Function, and Genetics 37(3): 334-45.
Langer, T. and E. M. Krovat (2003). “Chemical feature-based pharmacophores and virtual library screening for discovery of new leads.” Current Opinion in Drug Discovery & Development 6(3): 370-376.
Lipinski, C. A. (2000). “Drug-like properties and the causes of poor solubility and poor permeability.” Journal of Pharmacological and Toxicological Methods 44(1): 235-249.
Lipinski, C. A., F. Lombardo, et al. (1997). “Experimental and computational approaches to estimate solubility and permeability in drug discovery and development settings.” Advanced Drug Delivery Reviews 23(1-3): 3-25.
Lorber, D. M., M. K. Udo, et al. (2002). “Protein-protein docking with multiple residue conformations and residue substitutions.” Protein Science 11(6): 1393-1408.
Matter, H., K. H. Baringhaus, et al. (2001). “Computational approaches towards the rational design of drug-like compound libraries.” Combinatorial Chemistry & High Throughput Screening 4(6): 453-475.
Muegge, I. (2003). “Selection criteria for drug-like compounds.” Medicinal Research Reviews 23(3): 302-321.
Muegge, I., S. L. Heald, et al. (2001). “Simple selection criteria for drug-like chemical matter.” Journal of Medicinal Chemistry 44(12): 1841-1846.
Norinder, U., T. Osterberg, et al. (1999). “Theoretical calculation and prediction of intestinal absorption of drugs in humans using MolSurf parametrization and PLS statistics.” European Journal of Pharmaceutical Sciences 8(1): 49-56.
Oprea, T. I. (2000). “Property distribution of drug-related chemical databases.” Journal of Computer-Aided Molecular Design 14(3): 251-264.
Paul, N. and D. Rognan (2002). “ConsDock: A new program for the consensus analysis of protein-ligand interactions.” Proteins: Structure, Function, and Genetics 47(4): 521-33.
Proudfoot, J. R. (2002). “Drugs, leads, and drug-likeness: An analysis of some recently launched drugs.” Bioorganic & Medicinal Chemistry Letters 12(12): 1647-1650.
Rarey, M., B. Kramer, et al. (1996). “A fast flexible docking method using an incremental construction algorithm.” J. Mol. Biol. 261(3): 470-489.
Sadowski, J. (2000). “Optimization of the drug-likeness of chemical libraries.” Perspectives in Drug Discovery and Design 20(1): 17-28.
Schapira, M., R. Abagyan, et al. (2003). “Nuclear hormone receptor targeted virtual screening.” Journal of Medicinal Chemistry 46(14): 3045-3059.
Shoichet, B. K., S. L. McGovern, et al. (2002). “Lead discovery using molecular docking.” Curr. Opin. Chem. Biol. 6(4): 439-46.
Shoichet, B. K., S. L. McGovern, et al. (2002). “Lead discovery using molecular docking.” Current Opinion in Chemical Biology 6(4): 439-446.
SU, A. I., D. M. Lorber, et al. (2001). “Docking molecules by families to increase the diversity of hits in database screens: computational strategy and experimental evaluation.” Proteins: Structure, Function, and Genetics 42(2): 279-293.
Sun, Y., T. J. Ewing, et al. (1998). “CombiDOCK: structure-based combinatorial docking and library design.” J. Comput-Aided Mol. Design 12(6): 597-604.
Veber, D. F., S. R. Johnson, et al. (2002). “Molecular properties that influence the oral bioavailability of drug candidates.” Journal of Medicinal Chemistry 45(12): 2615-2623.
Walters, W. P., A. Murcko, et al. (1999). “Recognizing molecules with drug-like properties.” Current Opinion in Chemical Biology 3(4): 384-387.
Walters, W. P. and M. A. Murcko (2002). “Prediction of ‘drug-likeness’.” Advanced Drug Delivery Reviews 54(3): 255-271.
Wang, R. X., Y. P. Lu, et al. (2003). “Comparative evaluation of 11 scoring functions for molecular docking.” Journal of Medicinal Chemistry 46(12): 2287-2303.
Watson, P., M. Verdonk, et al. (2003). “A web-based platform for virtual screening.” Journal of Molecular Graphics & Modelling 22(1): 71-82.
Wessel, M. D., P. C. Jurs, et al. (1998). “Prediction of human intestinal absorption of drug compounds from molecular structure.” Journal of Chemical Information and Computer Sciences 38(4): 726-735.
Xu, J. and J. Stevenson (2000). “Drug-like index: A new approach to measure drug-like compounds and their diversity.” Journal of Chemical Information and Computer Sciences 40(5): 1177-1187.

1. A method for discriminating between a potential drug molecule and a potential non-drug molecule, comprising:
Providing a database of a plurality of drug molecules and a database of a plurality of non-drug molecules;
Partitioning said databases of drug molecules and non-drug molecules, into a training set and a test set for each database;
calculating values for at least one physicochemical descriptor for all the molecules in the two sets;
determining upper and lower limits of values for said at least one physicochemical descriptor;
applying a stochastic search for optimizing the values of the upper and lower limits of descriptors for said molecules;
scoring ability to discriminate between drug and non-drug molecules; and
discarding values that do not contribute to optimization of said ability to discriminate.

2. The method of claim 1, further comprising constructing histograms of the descriptors.

3. The method of claim 2, further comprising assigning, to each physicochemical variable, at least one descriptor, or two, in which one for the lower limit of its range of values, and the other for the upper limit.

4. The method of claim 3, wherein said ranges overlap.

5. The method of claim 1, further comprising:
continuing iterating and reducing the number of variable values until a predefined endpoint is achieved;
switching from stochastic to an exhaustive calculation of all remaining options.

6. The method of claim 1, further comprising:
sorting the results from the optimum “best filters” up to lesser results.

7. The method of claim 6, further comprising:
Selecting a plurality of filters according to optimization of said filters; and
Applying said plurality of filters to said test set for determining performance of said filters.

8. The method of claim 7, further comprising:
Combining a number of said plurality of filters to obtain a drug like index for distinguishing between drug and non-drug molecules.

9. The method of claim 1, wherein said filters comprise at least one descriptor from the plurality of available descriptors.

10. The method of claim 1, wherein an equation for determining whether a molecule is drug-like comprises an efficiency factor.

11. The method of claim 10, wherein said equation for determining whether a molecule is drug-like comprises:
$$DLI = \frac{{\sum }_{i = 1}^{n} {δ}_{Di} \frac{{P}_{Di}}{{P}_{NDi}} - {δ}_{NDi} \frac{{N}_{Di}}{{N}_{NDi}}}{n} \qquad ( 2 )$$
Wherein n is the number of filters, value of delta functions δ_{Di} and δ_{NDi} are set according to whether said molecule is a non-drug or a drug according to the currently calculated filter i, P_{Di} is the percentage of drugs that are predicted to be “drugs” according to filter i, while P_{NDi} is the percentage of false positives, N_{Di} is the percentage of drugs identified to be non drugs (false negatives) according to the current filter, and N_{NDi} is the percent of non-drugs identified by the current filter.

12. The method of claim 11, wherein a value of delta function δ_{Di} is 0 (Zero) if said molecule is a non-drug according to the currently calculated filter i, and 1 if it is a drug according to that filter, and wherein a value of the delta function δ_{NDi} is 1 if it is a non-drug according to the currently calculated filter, and 0 if it is a drug according to that filter.

13. The method of claim 10, wherein a quotient P_{Di}/P_{NDi}, is said efficiency factor of filter i for identifying drugs, and a quotient N_{NDi}/N_{Di} is said efficiency factor for identifying non-drugs.

14. A method for discriminating between a first type of item having a first characteristic and a second type of item having a second characteristic, comprising:
Providing a database of a plurality of items of said first type and a database of a plurality of items of said second type;
Partitioning said databases of items of said first and second types, into a training set and a test set for each database;
calculating values for at least one descriptor for all the items in the two sets;
determining upper and lower limits of values for said at least one descriptor;
applying a stochastic search for optimizing the values of the upper and lower limits of descriptors for said items;
scoring ability to discriminate between items of said first and second types; and
discarding values that do not contribute to optimization of said ability to discriminate.

15. A method for partitioning a set of molecules into a first set of at least one drug-like molecule and a second set of at least one non drug-like molecule, comprising:
Determining a statistical distribution of values for at least one characteristic over the set of molecules; and
Partitioning the set of molecules into the first and second sets according to the statistical distribution.

16. The method of claim 15, wherein said determining said statistical distribution of values is performed by:
Providing a first database of a plurality of drug-like molecules and a second database of a plurality of non drug-like molecules;
Selecting said at least one characteristic according to an ability of said at least one characteristic to distinguish between molecules in said first and said second databases.

17. The method of claim 16, wherein said ability of said at least one characteristic is determined by:
calculating the values of the physicochemical descriptors of interest for all the molecules in the two sets; and
determining a number of drug-like and non drug-like molecules partitioned according to said calculated values.

18. The method of claim 17, wherein said calculated values are calculated according to histograms of said descriptors.

19. The method of claim 17, wherein said determining said number of partitioned molecules further comprises:
Performing a stochastic search for optimal value or values of said descriptors; and
Partitioning said molecules according to said optimal value or values.

20. The method of claim 19, further comprising:
Performing an exhaustive search when a number of possible value or values of said descriptors is reduced to a threshold level.

21. The method of claim 17, further comprising:
Selecting at least one optimal physicochemical descriptor.

22. The method of claim 21, wherein said selecting said at least one optimal descriptor comprises:
Selecting a plurality of sets of descriptors, with a predefined range for each descriptor; and
Optimizing ranges of said sets of descriptors.

23. The method of claim 22, wherein said optimizing said ranges further comprises:
for a predetermined number of descriptors, n>1, applying a stochastic search for selecting the best sets of n descriptors;
discarding non-contributory descriptors; and
sorting results to obtain at least one optimal descriptor.

24. The method of claim 23, wherein said stochastic search is applied according to a cost function comprising the Matthews correlation coefficient as the scoring function to measure the ability to differentiate between drugs and non-drugs in the training set.

25. The method of claim 24, wherein said searching, discarding and sorting are repeated at least once.

26. The method of claim 25, wherein said searching, discarding and sorting are repeated until a threshold is reached.

27. The method of claim 21, wherein said selecting said at least one optimal descriptor comprises:
Assigning three variables to each descriptor, a first variable for the lower limit of its range of values, a second variable for the upper limit, and a third binary variable;
Performing a stochastic search for selecting the best sets of descriptors;
discarding non-contributory descriptors; and
sorting results to obtain at least one optimal descriptor.

28. The method of claim 16, wherein said ability is determined according to a predetermined threshold for discriminating between drug-like and non drug-like molecules.

29. The method of claim 28, wherein said predetermined threshold is determined according to a cost function.

30. The method of claim 29, wherein said function comprises the Matthews correlation coefficient.

31. The method of claim 15, wherein said determining said statistical distribution of values is performed by:
Providing a first database of a plurality of drug-like molecules and a second database of a plurality of non drug-like molecules; and
Selecting at least one filter for determining a cut-off between drug-like and non drug-like molecules according to an ability to discriminate between molecules in said first and second databases.

32. The method of claim 31, wherein said selecting said at least one filter comprises selecting a plurality of optimum filters in combination.

33. A method for distinguishing between a population of drug-like molecules and a population of non-drug like molecules, comprising:
determining a plurality of characteristics of the population of drug-like molecules and the population of non-drug like molecules;
providing a third population of molecules;
filtering said third population according to said plurality of characteristics; and
partitioning said third population according to said filtering, wherein said partitioning is performed according to a cut-off threshold, said cut-off threshold determining a degree of similarity of molecules in said third population to said plurality of characteristics of the population of drug-like molecules and a degree of non-similarity of molecules in said third population to said plurality of characteristics of the population of non-drug like molecules.

34. The method of claim 15, further comprising:
Determining a DLI (drug-like index) value for each molecule, said DLI forming a cut-off threshold for partitioning said molecules.

35. The method of claim 34, further comprising:
selecting a target for being bound by a drug-like molecule;
performing docking to model an interaction of each molecule with said target; and
combining a result of said docking with said DLI to select at least one molecule.

36. The method of claim 34, further comprising:
providing a library of molecules;
partitioning said library of molecules according to said DLI; and
selecting drug-like molecules after said partitioning for high throughput screening.

37. The method of claim 34, further comprising:
examining a plurality of scaffolds, each scaffold having a plurality of substituents at a plurality of positions;
partitioning said scaffolds according to said DLI.

38. The method of claim 37, further comprising:
selecting drug-like scaffolds according to said partitioning; and
selecting a plurality of substituents for said drug-like scaffolds according to said partitioning.

39. The method of claim 38, wherein said selecting comprises prioritizing said drug-like scaffolds and substituents for a screening assay.

40. The method of claim 38, wherein said selecting comprises prioritizing said drug-like scaffolds for selecting at least one lead for a new potential drug.
